(19) United States
(12) Patent Application Publication
(10) Pub. No.: US 2012/0131007 A1
(43) Pub. Date: May 24, 2012

(54) System and Method for Publishing

(76) Inventors: Anton A. Bougaev, La Jolla, CA (US); Aleksey Urmanov, La Jolla, CA (US); Eugene Kolinko, San Diego, CA (US); Joshua C. Walter, Kirkland, WA (US)

(21) Appl. No.: 13/233,024

(22) Filed: Sep. 15, 2011

Related U.S. Application Data
(60) Provisional application No. 61/383,680, filed on Sep. 16, 2010.

(51) Int. Cl. G06F 17/30

(52) U.S. Cl. 707/740; 707/736; 707/E17.089

(57) ABSTRACT

Computer implemented system and method for publishing evaluated information comprising collecting one or more sets of data from one or more users, generating one or more sets of augmented collected data by augmenting the one or more sets of data collected from the one or more users, wherein the augmenting the one or more sets of data includes implementing a typesetting function configured to associate identifier information with the collected one or more sets of data, detecting a request from the one or more users, providing at least one additional user at least a portion of the augmented collected data, wherein at least a portion of the provided augmented collected data includes identifier data associated with the one or more users, and assigning a recognized number to the augmented collected data.

### CROSS-REFERENCE TO RELATED APPLICATIONS

The present application is related to and claims the benefit of the earliest available effective filing date from the following listed application (the “Related Application”) (e.g., claims benefits under 35 USC 119(e) for provisional patent applications, for any and all parent, grandparent, great-grandparent, etc. applications of the Related Application).

### Related Applications:

For the purpose of the USPTO extra-statutory requirements, the present application claims benefit of priority of U.S. Provisional Patent Application No. 61/383,680, entitled DOCUMENT PUBLISHING TOOL.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statue. Applicant understands that the statue is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Application and of any and all parent, grandparent, great-grandparent, etc. applications of the Related Application is incorporated herein by reference to the extent such subject matter is not inconsistent herewith.

### TECHNICAL FIELD

The present disclosure generally relates to a publication system, particularly one suitable for collaboration.

### SUMMARY

In one aspect, a method includes a computer implemented method of publishing evaluated information comprising collecting one or more sets of data from one or more users, generating one or more sets of augmented collected data by augmenting the one or more sets of data collected from the one or more users, wherein the augmenting the one or more sets of data includes implementing a typesetting function configured to associate identifier information with the collected one or more sets of data. Upon a request from the one or more users, providing at least one additional user at least a portion of the augmented collected data, wherein at least a portion of the provided augmented collected data includes identifier data associated with the one or more users, and assigning a recognized number to the augmented collected data.

In another aspect, a method includes a computer implemented method of sharing evaluated information comprising collecting one or more sets of data from one or more users, generating one or more sets of augmented collected data by augmenting the one or more sets of data collected from the one or more users, wherein the augmenting the one or more sets of data includes implementing a typesetting function configured to associate identifier data with the collected one or more sets of data. Upon a request from the one or more users, providing at least one additional user at least a portion of the identifier data associated with the one or more users and at least a portion of the identifier data associated with the augmented collected data, generating one or more additional sets of augmented collected data by augmenting one or more additional sets of collected data from the at least one additional user, wherein the one or more additional sets of collected data include at least one of an evaluation set of data indicative of a user evaluation of the one or more sets of augmented collected data or a modification set of data indicative of a user modification of the one or more sets of augmented collected data, and assigning a recognized number to the one or more additional sets of augmented collected data and the augmented collected data.

In yet another aspect, a system includes a system for sharing evaluated information comprising: (one or more information exchange interfaces) one or more processors coupled to memory, wherein the memory stores program instructions executable by the one or more processors in order to implement an information exchange module to collect one or more sets of data from one or more users, an augmentation module to generate one or more sets of augmented collected data by augmenting the one or more sets of data collected from the one or more users, wherein at least a portion of the augmenting includes initiating a typesetting function associating identifier information with the collected data, a request module to implement a request from the one or more users a display module to provide at least one additional user at least a portion of identification data associated with the one or more users and at least a portion of identification data associated with the augmented collected data, an additional augmentation module to generate one or more additional sets of augmented collected data by augmenting one or more additional sets of collected data from the at least one additional user, wherein the one or more additional sets of data include at least one of an evaluation set of data indicative of a user evaluation of the one or more sets of augmented collected data or a modification set of data indicative of a user modification of the one or more sets of augment collected data, and an assignment module to assign a recognized number to the one or more additional sets of augmented collected data and the augmented collected data. In addition to the foregoing, other aspects of the system are described in the claims, figures, and description contained within the present disclosure.

The above summary is for illustrative purposes only, and is not intended to be in any way limiting. The summary may contain simplifications, embodiments, inclusions or omissions of detail, or further aspects which those skilled in the art will appreciate are not limiting.

### BRIEF DESCRIPTION OF THE FIGURES

FIG. 1 is a high-level schematic of a computer implemented system for publishing evaluated information.

FIG. 2 is illustrates the function and interaction of an information exchange interface and an information exchange module.

FIG. 3 is a sub-module for formatting and augmenting data.

FIG. 4 is an illustration of a typesetting function for typesetting data.

FIG. 5 is a module for presenting user generated data to the public.

FIG. 6 represents a module for displaying system data to multiple system users.

FIG. 7 is a submodule for formatting data and associating the data with additional data.

FIG. 8 is a module for assigning a recognized number to data.

FIG. 9 displays exemplary forms of data.

FIG. 10 displays exemplary sets of data.

FIG. 11 is a process flow chart for publishing evaluated information.

FIGS. 12-27 illustrate alternate processes for publishing evaluated information.

### DETAILED DESCRIPTION

In the following detailed description, reference is made to the accompanying drawings, which form a part hereof. In the drawings, similar symbols typically identify similar content, unless context dictates otherwise. The illustrative embodiments described in the detailed description, drawings, and claims are not meant to be limiting. Other embodiments may be utilized, and other changes may be made, without departing from the spirit of scope of the subject matter presented here.

With respect to the use of substantially any plural and/or singular terms herein, those having skill in the art can translate from the plural to the singular and/or from the singular to the plural as is appropriate to the context and/or application. The various singular/plural permutatinos are not expressly set forth herein for the sake of clarity.

While particular aspects of the present subject matter described herein have been shown and described, it will be apparent to those skilled in the art, based upon the teachings herein, changes and modifications may be made without departing from the subject matter described herein and its broader aspects and, therefore, the appended claims are to encompass with their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms.

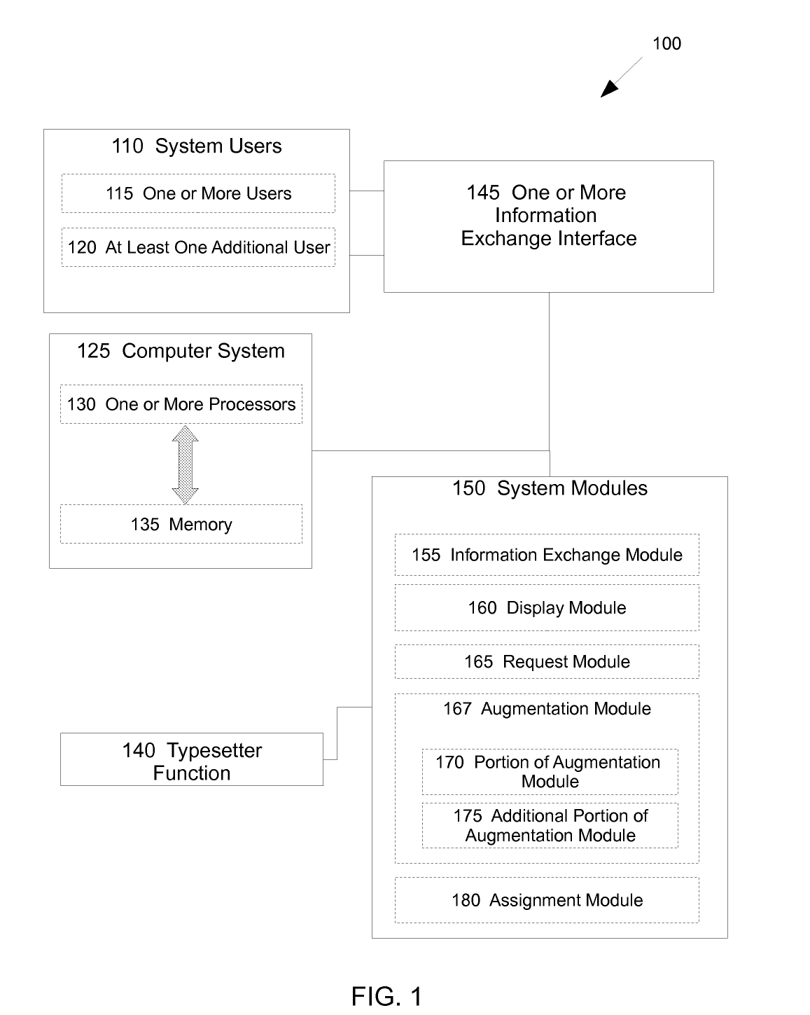

Referring generally to FIGS. 1 through 10, a system 100 for sharing evaluated information is described, herein, in accordance with the present disclosure. The system for sharing evaluated information consists of one or more information exchange interfaces 145 and system modules 150. These computer enacted systems 125 allow one or more system users 110 to interact with the system modules. One or more system users may comprise any user or group of users. A user may be an author or creator of content in addition to one or more persons interfacing content with the system 100 that may have been created by other users. In one example, the one or more users 115 is a group of individuals working on a scholarly article. In another example, the one or more users are a group working on a corporate project. In yet another example, the one or more users is a musician interfacing or creating musical content on the system 100. It should be noted, that the one or more users may be any user capable of creating any type of content, such as book, work of collaborative effort, technical or legal documents, personal documents such as autobiographies or journals, blog-type content, technical specifications, meeting notes or memos, or the like. FIG. 1 further illustrates a system user may be one or more additional users, 120. The one or more additional users may be any user, including users having characteristics different than the one or more users. For some aspects, one or more additional users may include one or more users having a portion of characteristics differentiated from the one or more users. In another aspect, the one or more additional users may be inferred broadly to mean any user or users besides the one or more users, such as other system 100 users, system 100 administrators, or users with access to portions of system 100 without usage capabilities. Any user with access to system 100 without system 100 usage capabilities may be considered, without limitation, a user representative of the general public or a user with web-access capabilities for interacting with a portion of the system 100. For the purposes of the description herein, one or more users 115 and at least one additional user 120 may be generally referred to as ‘user’ or ‘users’. Where specific reference or illustration is required or necessary for understanding discussion, the specific user type 115 or 120 will be specified, however it should be understood that user roles may be interchangeable in totality, or in part for some functions which will be further described, herein.

The system users 110 interface with the system modules 150 through the use of one or more information exchange interfaces. The one or more information interface 145 can be any computer system capable of communication with computer system 125. This may include a user interfacing with computer system 125 through the use of one or more information exchange interfaces 145, such as personal computer, laptop, cellular phone, smart phone, or the like. The communication may occur by any means, such as through a connection to the world wide web using any network type, such as a wired or wireless network, a local area network, a cellular network or the like. Users may also interface with the computer system 125 directly, wherein the one or more information exchange interfaces 145 is a sub-component of the computer system, 125. In this case, the one or more users may be an administrator of the system 100 or a user who has installed the system modules 150 and other necessary software to implement certain features of system 100. The computer system 125 is coupled to memory, 135. Instructions for the execution of commands by the processor may be stored in memory, the memory being of any form such as a hard drive memory, flash drive memory, external or floppy drive memory, or the like. The memory 135 may comprise one or more of the above mentioned memory forms and in some cases can be located, permanently or temporarily, outside of system 100. In such cases, a user or administrator may store information on their local systems for interface with the computer system 125 at such time as desired by the user(s). The computer system 125 also comprises one or more processors, 130. Without limitation, the processors may be a single processor, a set of processors, or a set or sets of parallel processors. It should be understood that processing can be allocated to multiple processors at multiple locations, such as with distributed computing.

For the purposes herein, and without limitation, the computer system 125 is considered a computer system which enacts system modules 150 and typesetter function 140. The computer system additionally couples system users with the system modules and typesetter function through one or more information exchange interfaces. System modules 150 comprise an information exchange module 155, a display module 160, a request module 165, an augmentation module 167 having multiple portions, such as a first portion of an augmentation module 170 and additional portion 175, and an assignment module 180. It should be understood by one of ordinary skill in the art, that the individual system modules may be coupled directly, or indirectly to other system modules or portions of system modules. The system modules 150 are connected to the computer system 125 and memory 135. In this way, each module may store or access information developed by the one or more users, various system modules, and typesetter function 140. Typesetter function, 140, is enacted and acts upon system modules to implement a set of commands, associations, requirements, restrictions, or changes (generally referred to as augmentations) upon one or more user submitted data as will be described further herein, below.

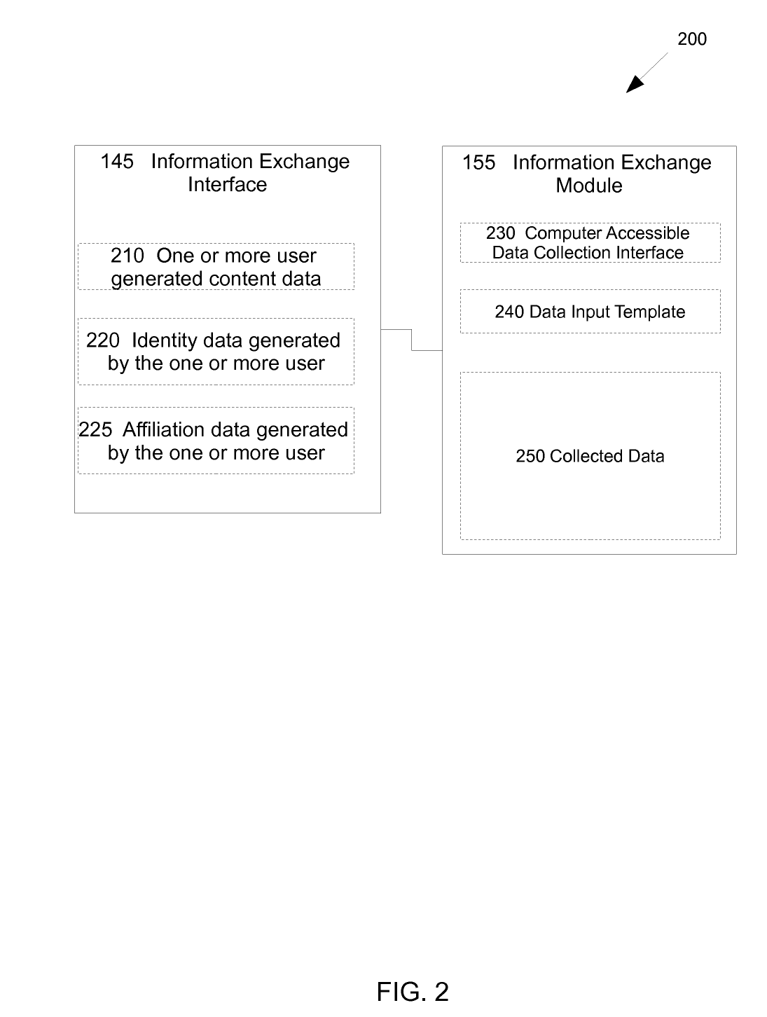

FIG. 2 illustrates the information exchange interface 145 and information exchange module 155. The information exchange interface may be considered, without limitation, one or more computer systems accessible by the system users, such as a users computer, laptop, or any other suitable electronic device. The user communicates with the information exchange module via the information exchange interface by way of any network connection, such as a network connection providing access to the world-wide web. Through this connection, the system users 110 may interact with the system modules 150, remotely. In this sense, the user enacts a web-accessible program consisting of the system modules 150. The information exchange interface, 145 is used by the users (i.e. the one or more users and the one or more additional users) to exchange user generated content data 210 (content submitted by the users, such as academic research content, content for a book or technical manual, content for a musical composition, content for multi-media applications, content for application for permits or licenses, or the like), identity data generated by the users 220 (e.g. information indicating a users identity, scholarly status such as collegiate degrees obtained, interests, hobbies, locality information, financial information such as bank or credit card information, or the like), and further personal information such as personal information related to the affiliation of the users 225 (e.g. place of employment or work, professional associations such as membership to societies, association with research or professional groups, association with volunteer organizations, association with clubs, local associations, amateur associations, or the like). Users interface this information with system 100 through the information exchange module 155. The information exchange module provides a user interface for submitting user information or content to the system 100. The information exchange module 155 provides the user one or more data input templates. The data input template has several features, some of which will be described for purposes of illustration, not limitation. The data input template may include a set of fields provided to the user from the system 100. The fields may include fields for entering any content data, such as text, multimedia data, graphical data or representation, symbolic data, audio, video, computational code, computational code output, descriptions or portions of all of the above (title, section description, abstract, references, etc.) or, more generally, any information that is desired to share, publish, or make accessible to users. Fields, or queries, provided through the use of the data input template 240 to the user for entry of information may include information to associate an information type with the entered data. The information type information may be considered identifier information of the form of general user generated data 210, identity data generated by the user 220, and data associated with the affiliation of the user 225, in addition to identifier data for use by the one or more system modules 150. As will be described further, herein below, identifier data for use by the one or more system modules may include data which associates a formatting requirement to the one or more fields such that the data can be associated with the one or more users, the one or more users personal data, or the one or more users data of any type stored in memory 135. The identifier data further allows for the storage of discrete portions of collected data within the memory system and allows for organization, formatting, access, retrieval, reorganization, or reuse of the user generated data, personal data, or affiliation data (i.e. collected data 250) by any one or more of the system modules 150, or any user through the use of the system 100. Any data submitted to the system 100, whether generated by the users or generated by one or more of the system's modules in association with one or more users data or one or more additional users data may have identifier data associated with it. By way of further illustration, a user may use a system 100 to incorporate or reference portions of concurrent or previous works with a present work. Again, by way of illustration, a user may use system 100 to reference or directly incorporate the work of another user, such as a co-author or collaborator, or one or more additional users, such as a work by a different author having information relevant to the user's work, into a present work of the user. The one or more information exchange interface 145 may be accessible by any number of other system modules 150 for exchange of any information. System modules 150 may also provide users data through the one or more information exchange interface.

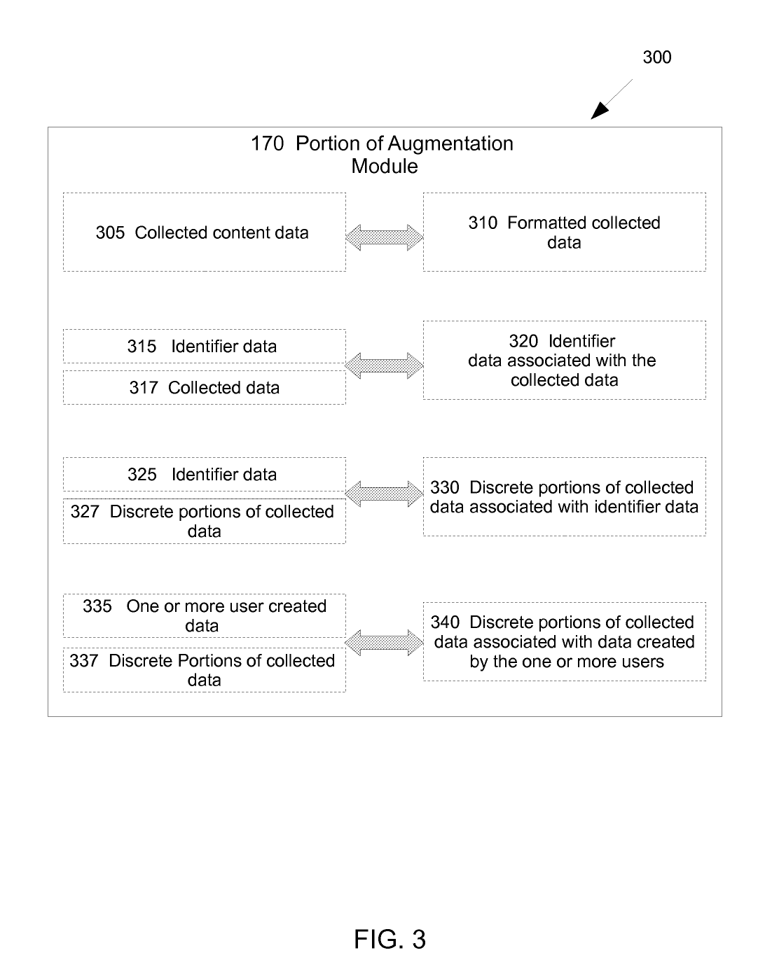

FIG. 3 illustrates the augmentation module 300 with a portion of the augmentation module 170. The portion of the augmentation module 170 converts collected data to formatted collected data, wherein the formatting process controls the look and style of the collected data for display to one or more users or one or more additional users. Formatting styles include, without limitation, font sizes, font faces, column numbers, line spacing, table styles and spacing, figure styles, and user information styling. As an example, user information styling may comprise author information styling, wherein author information styling may include styles selected or produced by users and enacted upon the collected data by the system 100 or one or more of its modules. As mentioned above, the collected data can be stored in discretized forms associated with identifier data. The identifier data can be used to indicate one or more formatting requirements associated with the discretized forms of data. In this way, for example, figure styles, table styles, fonts, or even overall document layout, such as any organization of the collected data, can be associated with different user submitted data such as would be needed to create a document second, chronologically, to a first paper having the same or similar styles or layout of the first paper. As a further example, a group of users publishing within a topical area or business area may publish documents from different users having a style consistent for all users within the group. Any system user 110 may affiliate or belong to a group. The group may have a consistent set of styles or formatting requirements which are characteristic of the group and their work or content. Groups may additionally be assigned a style by the system 100 or create styles and formats for use by the system.

The portion of augmentation module 170 initiates a typesetting function 140 for formatting collected data 305, which may be any portion of the collected data 250. The formatted collected data 310 is any content formatted by any of the above described means. Additionally, the collected data 305 may be formatted in any number of ways with multiple versions storable via any memory means, such as those described above. The portion of the augmentation module 170 may also combine identifier data 315 and collected data 317, wherein a portion of collected data 317 way be any portion of collected data 305 or 250. In this way one or more users identifier data may be associated with one or more users collected data. It should be understood that identifier data 315 and identifier data 317 may be a similar set of identifier data, or a different set of identifier data such as a subset of identifier data. Identifier data or portions thereof may be combined with discrete portions of collected data 325. In this way, one or more users collected data may be combined with identifier data, such as author association with a text document or portions of the text document, such as figures, paragraphs, web-based content, and the like. In yet another example, identifier data such as an identifier number may be associated with multiple discrete portions of collected data 325, where the discrete portions of collected data 325 may originate from a different set of collected data such as collected data 305. For example, one or users may combine previous works to create a new work, which may be represented as a distinct, yet still parsable, set of collected data with any associated identifier data. As an example, the new work may have a new set of authors, standard numbers or publisher data (e.g. catalogue number, business number, ISSN, ISBN, patent number, part number, web-id, information about any associated group, publisher identification, etc. . . . ). The work may incorporate portions of works by other authors simply be reference, such as associating by embedding or referencing other collected data and identifier data into the new work. The work may incorporate portions of works by other authors by embedding the collected data, where the collected data may be associated with the other authors identifier data. As an example, an author may incorporate video with the video source being identified. In another example, a work may have embedded computational code with the computational code source being identified. By way of further example, and not limitation, the work may have any form of collected data or content as described above embedded. The augmentation module 170 may make any association on behalf of the users, such that associated data may be automatically incorporated into a work with identifier data. As was mentioned previously, identifier data may be of the form of data associated with a formatting requirement or of the form of identifier data associated with a users personal or affiliation data. As an example, an author wishing to embed a figure or table may reference the figure or table and incorporate the figure or table into a new work without knowledge of formatting requirements previously used in the source work to enhance or maintain visual quality. The augmentation module 170 enacts typesetting function 140 which may preserve any previous requirements for association with the new work or it may create new requirements yet still retaining original identifier data.

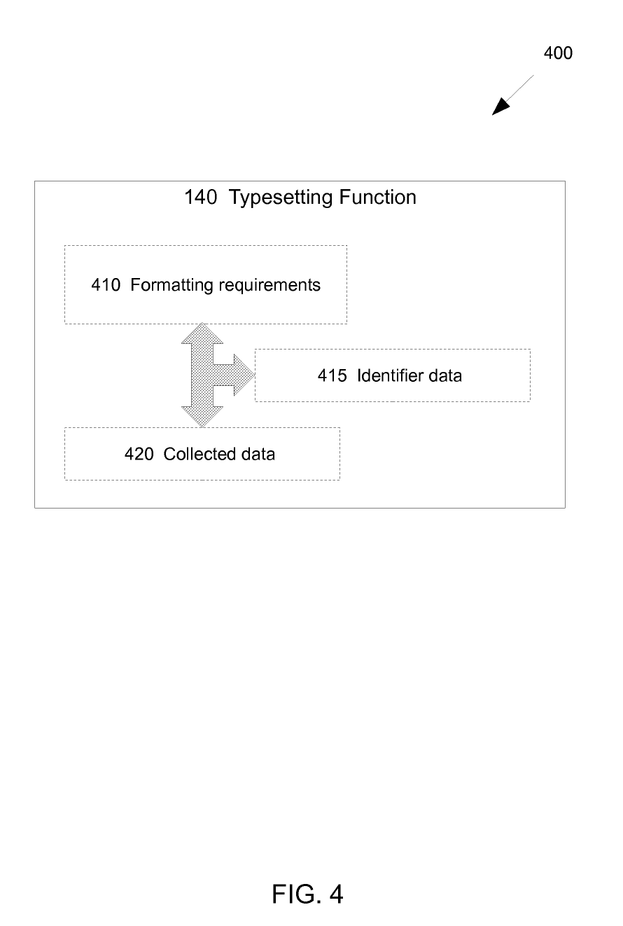

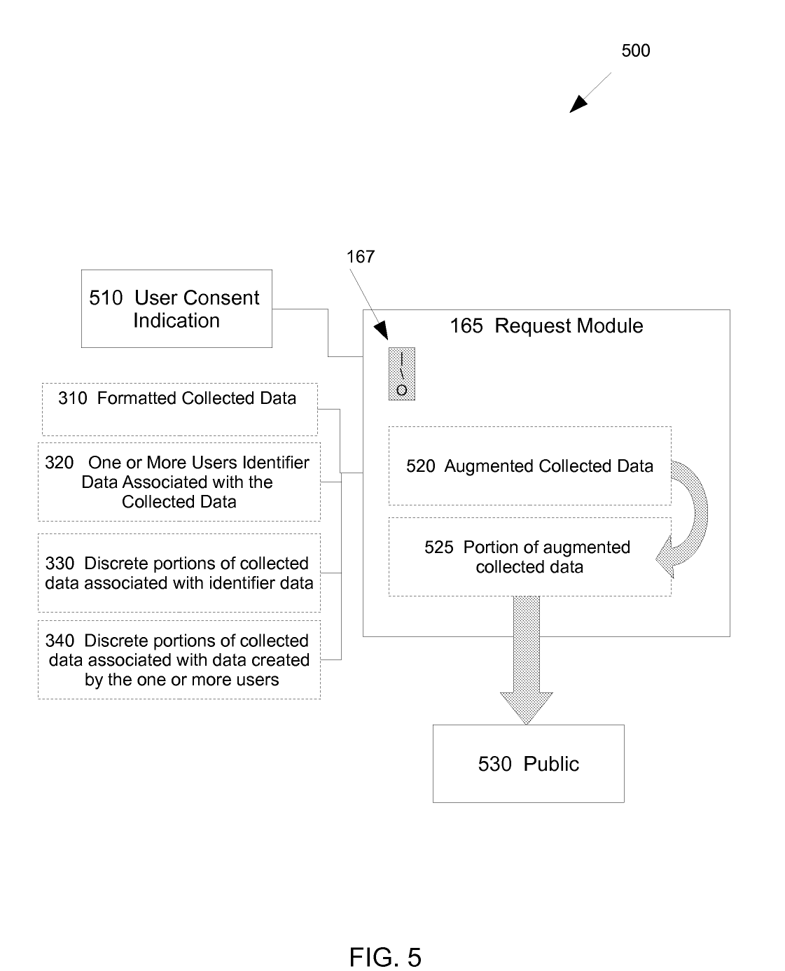

The typesetter function 140 is illustrated in FIG. 4. In this example, the typesetter is combining or associating a set of collected data 420, identifier data 415, and formatting requirements 410. The typesetter may make any combination or association and store to memory any newly created collected data to memory for use by any one or more modules. Additionally, the typesetter may be enacted by any module to create a set a combination set or association set of collected data for use by system 100 or any system user 110.

Still referring to FIG. 4, the typesetting function may be enacted asynchronously or synchronously relative to the users. As an example, the typesetting function may be enacted to produce formatted collected data on behalf of the user. The formatted data may be accessed by the display module 160 to present users a real or near to real time visual display of the formatted data. Any of the above mentioned associations may be performed on behalf of the user. In some cases, the user may enact the typesetter through one or more modules, such as the information exchange module 155, request module 165, or assignment module 180, synchronously. The user may enact the typesetter function by requesting to save a work by selecting the save function through the information exchange module. The augmentation module would then call the typesetter function to fulfill the user task. Other non-limiting examples may include selecting a publish function, a formatting adjustment function (eg adjusting text, figures, or table), or choosing and then associating portions of collected data. An example showing a request system 500 is illustrated in FIG. 5. User consent indication is accepted by system 500 by any number of mechanisms, such as a switch 167, or visual equivalent, such as a computer generated button or selector, which enacts request module 165. Request module 165 takes any formatted collected data 310, 320, 330, 340 which may be represented or reconfigured to form augmented data 520. Upon a user enacted consent indication, the entirety of or a portion of the augmented data is published or made public. Portions of the data which, in some cases, can be kept from public view may include portions of identifier data associated with styles or formatting, pagination, and general layout not necessary to the understanding of the augmented collected data. As will be discussed further below, the portion of data made available to the public may have a number associated with it, such as a control number, catalogue number, publisher number, internal number, standard number, etc. This number may serve as reinforcement of the published material, such that it indicates ownership of copyright. Additionally, collected data, including portions of collected identifier data, may contain copyright data, wherein copyright data may include usage privileges or requirements for any user of the data, including system users 110.

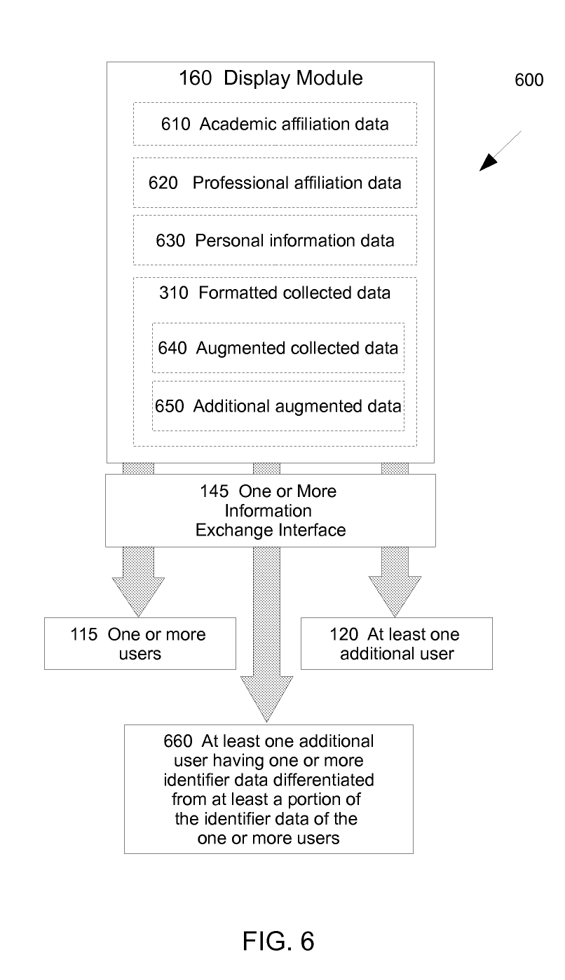

FIG. 6 shows a system for displaying various forms of collected data 600. The system utilizes the display module 160 to present multiple forms of collected data (310, 610, 620, 630, 640, and 650) to the one or more user 115, one or more additional user 120 (i.e. system users 110), or at least one additional user having one or more identifier data differentiated from at least a portion of the identifier data of the one or more users 660. For example, a user can use the display module to display their own data to themselves. A user can use the display module to display data to one or more additional user. Furthermore, data can be displayed to one or more user which is distinguishable from the one or more user or the one or more additional users, or both. In this way, augmented collected data may be made available to colleagues or piers for either collaboration, review, contribution, negation, or critique and may be done in a way which minimizes, eliminates, or indicates those users with a professional or affiliation related conflict of interest.

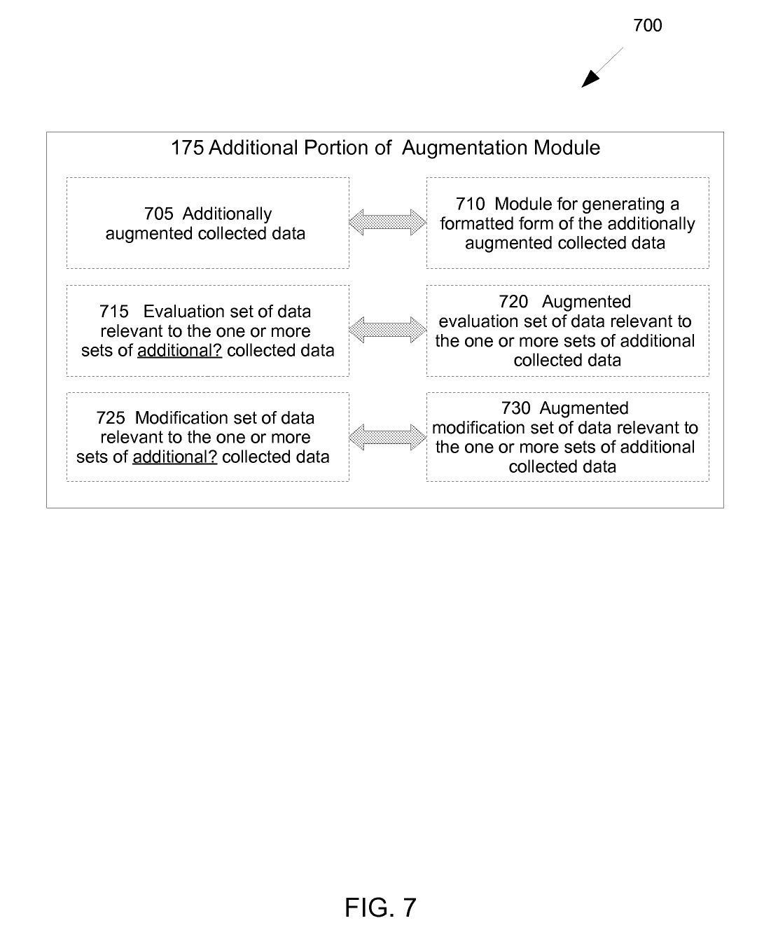

Augmented data made available to colleagues or peers (generally other users) can be used by those colleagues or peers. As was discussed above, portions of the augmented collected data may be incorporated by another user into a work for which they are a creator. Another example of how information can be used is illustrated in FIG. 7, which shows an augmentation system 700 for managing or treating collected data generated by a user in response to data generated by a different one or more users. The additional portion of augmentation module 175 may convert additionally augmented collected data 705 to a formatted form of the additionally augmented collected data 710. Furthermore, the additional portion of augmentation module 175 may transform an evaluation set of data relevant to the one or more sets of (additional?) collected data 715 to an augmented form of data relevant to the one or more sets of augmented collected data 720. A similar process can be enacted upon a modification set of data 725 to create an augmented modification set of data relevant to the one or more sets of additional collected data 730. Augmented data 705 may include data responsive to data generated by another user. The data may be responsive and relevant and may include the users augmented collected data in a modified form. As an example, the augmented collected data could be a musical composition. An additional user may find interest in the musical composition and write commentary based on the composition. Furthermore, the additional user may critique the musical composition. If the augmented collected data contains the raw music data (i.e. written musical composition, audio files, or sound tracks or bites) the additional user may modify the composition with such modification being a portion of the additional users collected data, which may further get augmented and published by the additional user, with or without consent of the creator of the musical composition which created the original collected data. In such cases, identifier data can be used to reference or cite the original creator with or without interference or action from the additional user. In this way, the system 100 can create a collaborative environment for reviewing and or modifying user created works. In another way, system 100 can create a peer review system wherein the user can seek solicit or receive peer review for any of their augmented collected data. In yet another way, professional documents, such as forms, applications, permits and the like, may be generated by a user for use or modification by an additional user. As with the portion of the augmentation module 170, the additional portion of augmentation module 175 may initiate the typesetting function to generate augmentations and associations in any manner similar to portion of augmentation module 170.

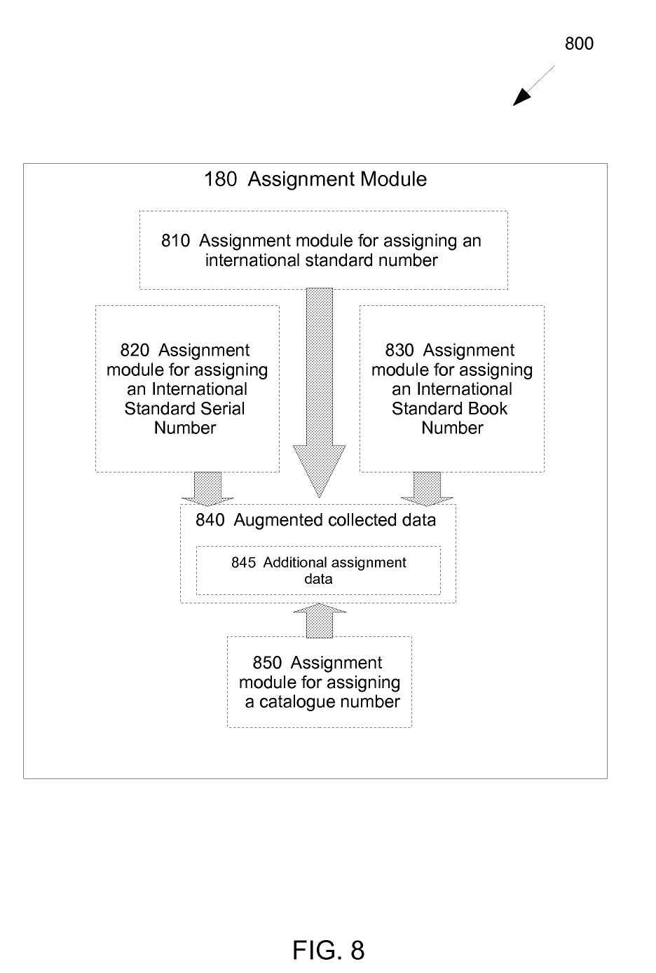

FIG. 8. illustrates a system 800 for assigning a number, such as an international standard number (or any of numbers or data describe above) to the augmented form of the additionally collected data or to the augmented form of collected data using the assignment module 180. Assignment module 180 may have multiple additional assignment modules for assigning a standard number, such as a catalogue number 850, international standard serial number (ISSN) 820, international standard book number (ISBN) 830, digital object identifier (DOI), or similar. Furthermore, the assignment module may assign a standard number to collected data which may serve as identifier data. Augmented collected data may multiple assigned standard numbers. For example, the augmented collected data may have identifier data associated to discrete portions of the augmented collected data which are for use by thy system 100. The augmented collected data may have an assigned standard number which indicates a publication type, publisher identification, topical group, or collected data type. The augmented collected data may have one or more standard number assigned to the whole of the collected data. In such cases, an additional user's augmented collected data may contain subsets of augmented collected data which were created by a user which already assigned a standard number to the augmented collected data. In such a manner, subsets of data shared or utilized between users can be identified and organized by system 100 for continued collaborative use. In this way, augmented collected data 840, for example, may be associated with additional assignment data 845.

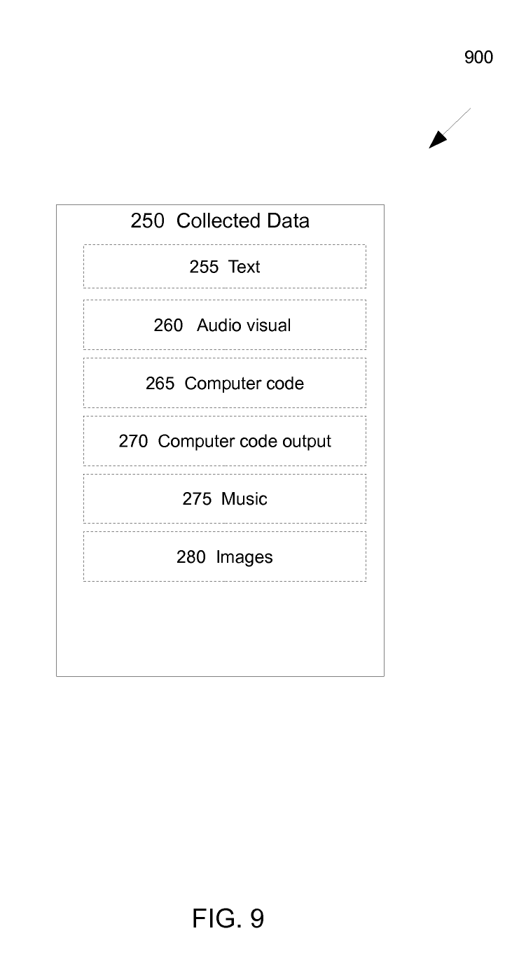

FIG. 9 illustrates exemplary, without limitation, collected data which may be utilized within or by system 100 by the system users 110. Examples in FIG. 9 include collected data 250, such as textual data 255, audio visual data 260, computer code 265, computer code output 270, music 275, or images 280. In general, any content parsable, storable, or manipulatable by computer system 125 may be utilized by system 100.

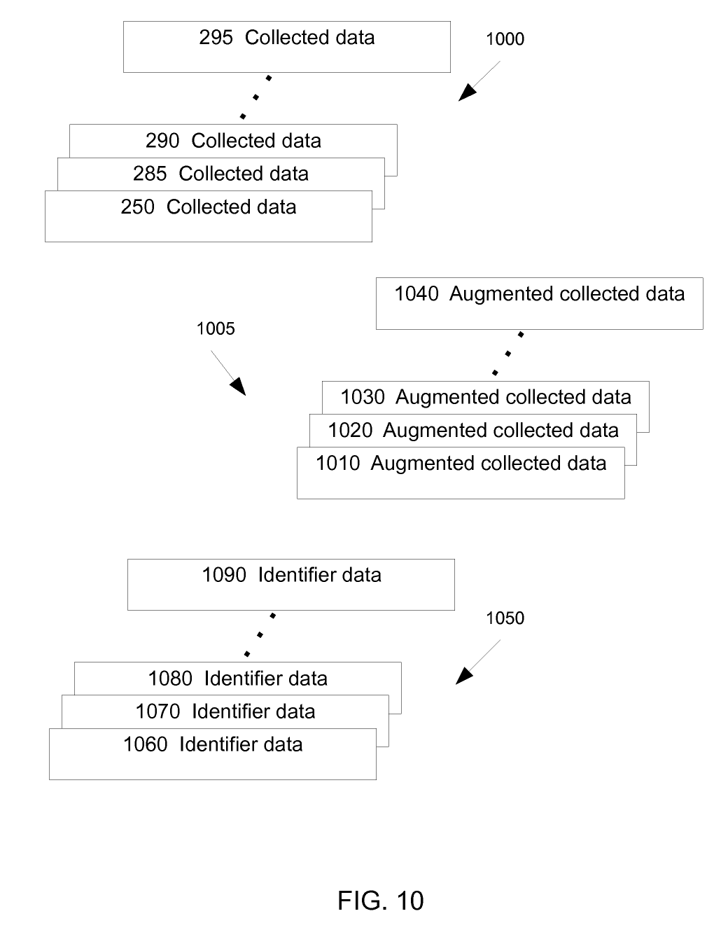

FIG. 10 illustrates the concept that sets of data by consist of multiple subsets or discrete portions. For example, data set 1000 may consist of multiple collected data sets 250, 285, 290, through collected data set 295. Data set 1005 may consist of multiple augmented collected data sets 1010, 1020, 1030, through augmented collected data set 1040. Data set 1050 may consist of multiple identifier data sets 1060, 1070, 1080, through identifier data set 1090.

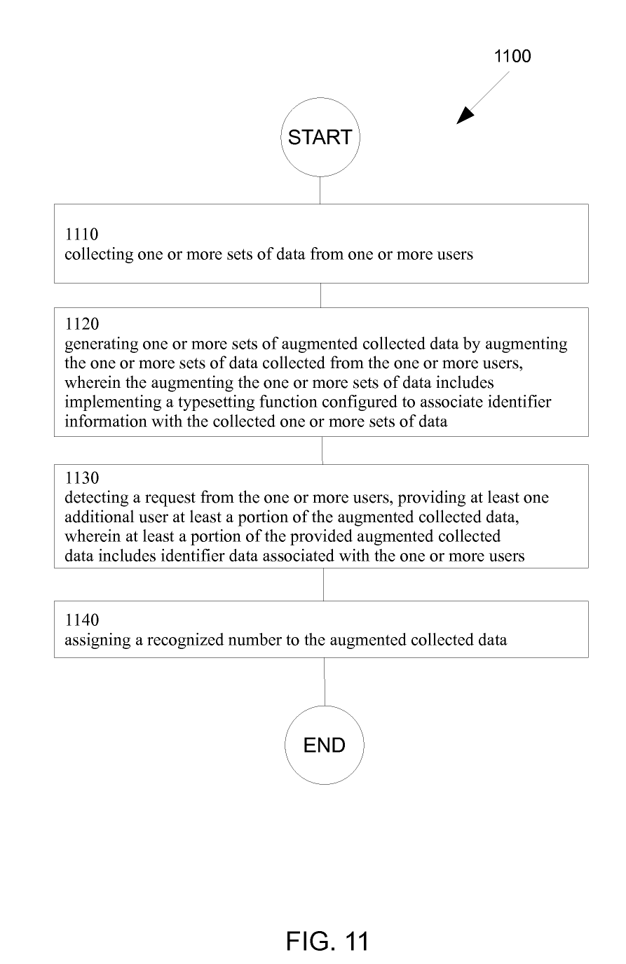

FIG. 11 through FIG. 27 are flowcharts depicting methods and aspects thereof. The flowcharts show exemplary methods and alternative implementations. Those skilled in the art should appreciate that additional methods and aspects may be described or implemented without departure from the scope or spirit of what has been previously described herein above and herein forth.

FIG. 11 illustrates operation 1100 related to a computer implemented method of publishing evaluated information comprising collecting one or more sets of data from one or more users 1110, generating one or more sets of augmented collected data by augmenting the one or more sets of data collected from the one or more users, wherein the augmenting the one or more sets of data includes implementing a typesetting function configured to associate identifier information with the collected one or more sets of data 1120, detecting a request from the one or more users, providing at least one additional user at least a portion of the augmented collected data, wherein at least a portion of the provided augmented collected data includes identifier data associated with the one or more users 1130, and assigning a recognized number to the augmented collected data 1140. FIG. 11 through FIG. 27 include examples of operation, use, and explanation with regards to FIG. 1 through FIG. 10 and associated descriptions and illustrations included with respect to those figures. Regarding order of figures, it should be understood by those skilled in the art that the methods and aspects set forth may be achieved in a variety of chronological sequences and contexts or environments without deviation from systems, aspects, and methods described herein.

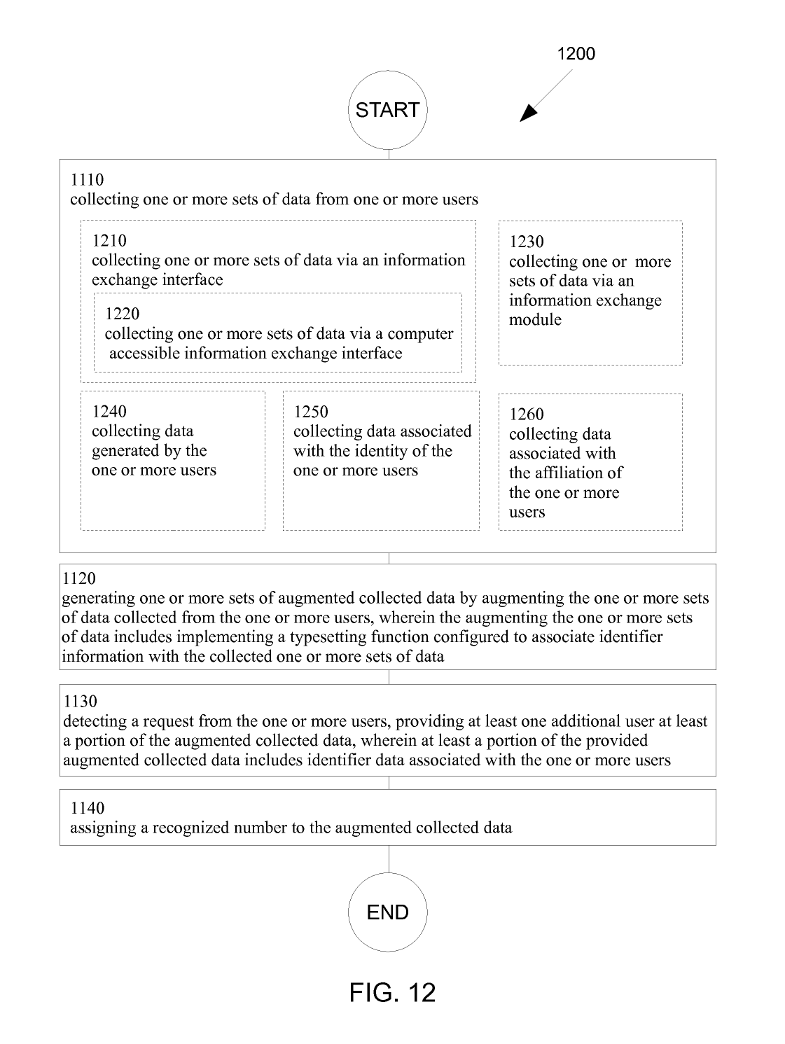

FIG. 12 illustrates an operation 1200 wherein the start of the operation is followed in further detail of operation 1110 by collecting one or more sets of data via an information exchange interface 1210. Operation 1210 may further be illustrated by collecting one or more sets of data via a computer accessible information exchange interface 1220. Operation 1110 may also include collecting one or more sets of data via an information exchange module 1230, collecting data generated by the one or more users 1240, collecting data associated with the identity of the one or more users 1250, or collecting data associated with the affiliation of the one or more users 1260. Operation 1200 may be included with operations 1120, 1130, or 1140.

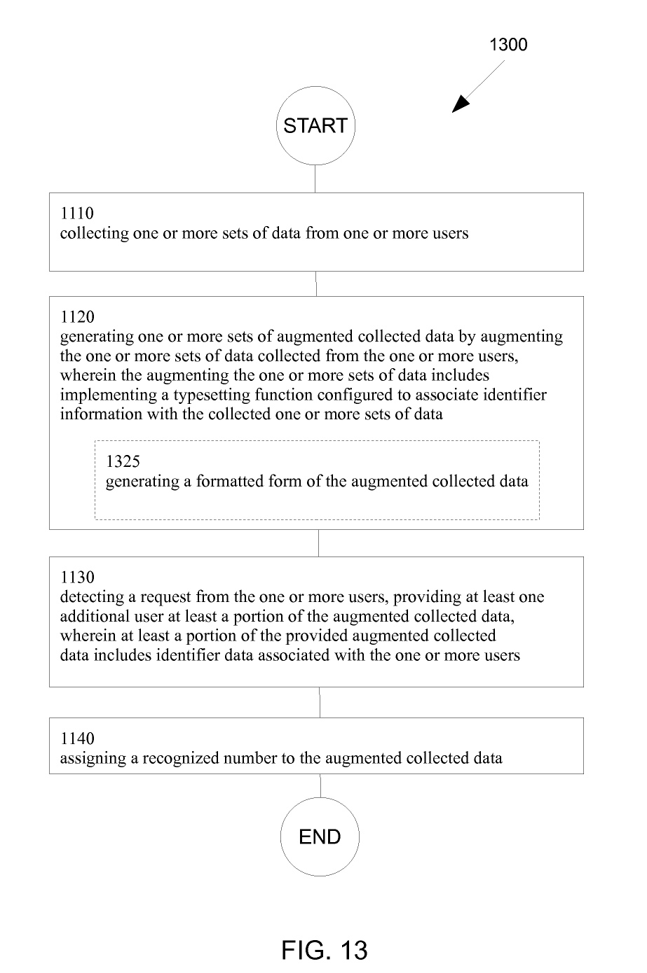

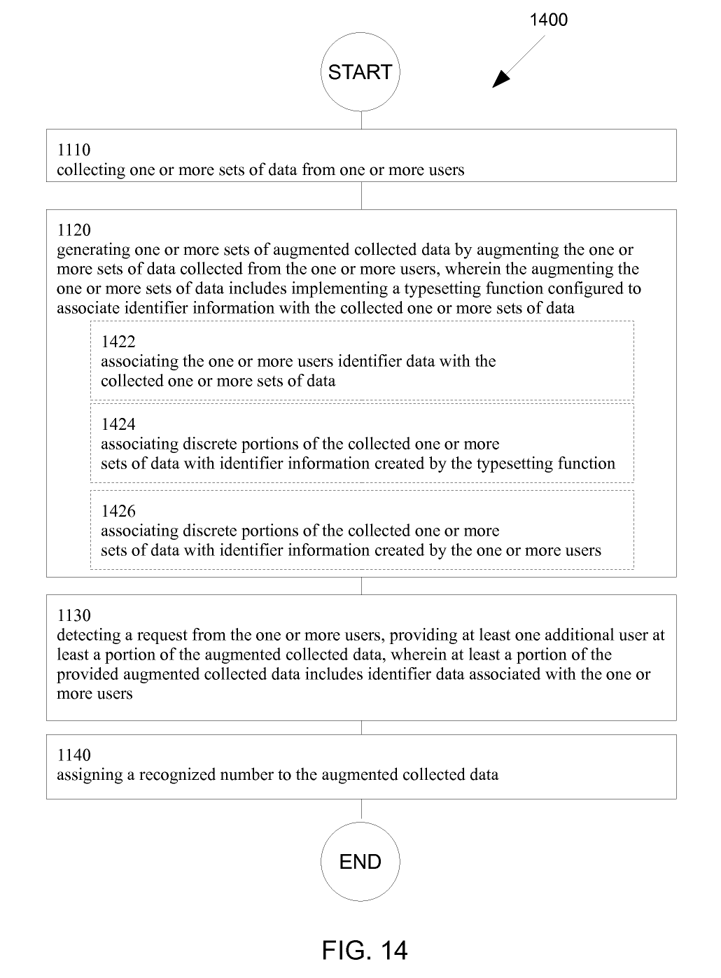

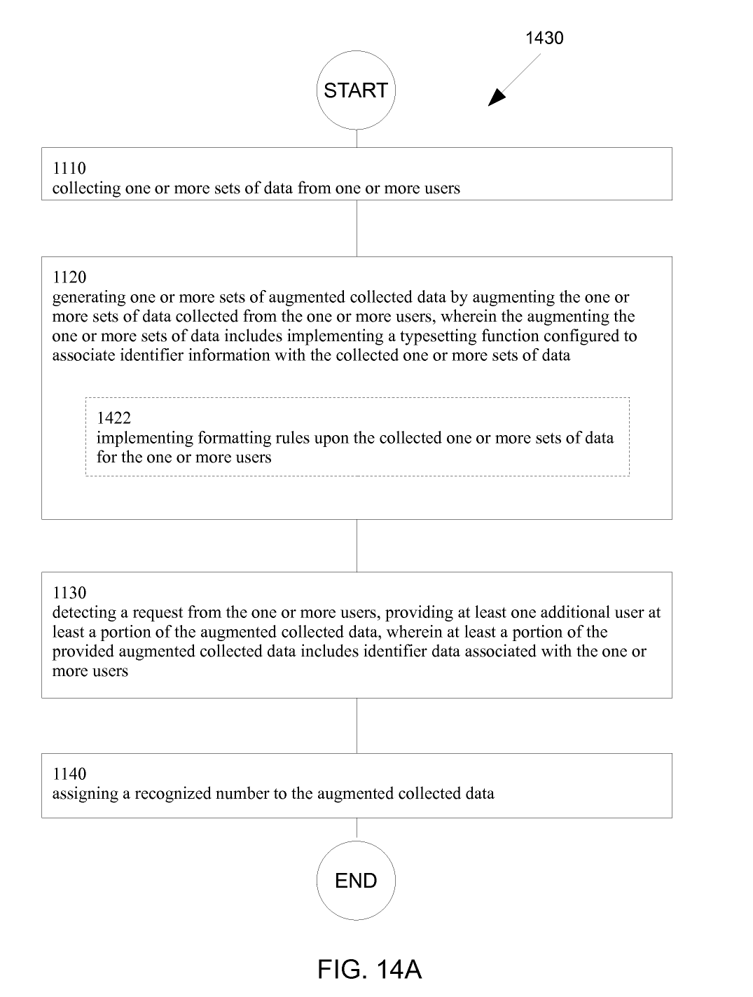

FIG. 13 illustrates a further embodiment through operation 1300. Operation 1300 includes operation 1110, 1120, 1130, or 1140. Operation 1120 may further include generating a formatted form of the augmented collected data 1325. Furthermore, as illustrated through operation 1400 of FIG. 14, operation 1120 may further include an operation 1422 for associating the one or more users identifier data with the collected one or more sets of data, an operation 1424 for associating discrete portions of the collected one or more sets of data with identifier information created by the typesetting function, or an operation 1426 for associating discrete portions of the collected one or more sets of data with identifier information created by the one or more users. Operation 1120 may further comprise a function 1440 for implementing formatting rules upon the collected one or more sets of data for the one or more users as illustrated in FIG. 14A via operation 1430.

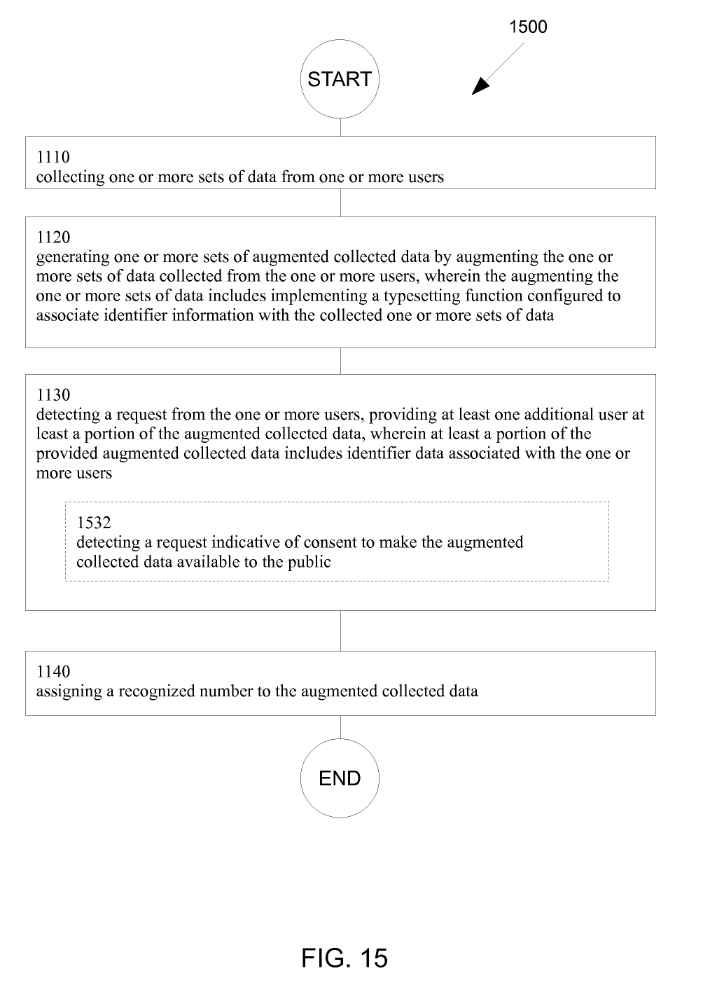

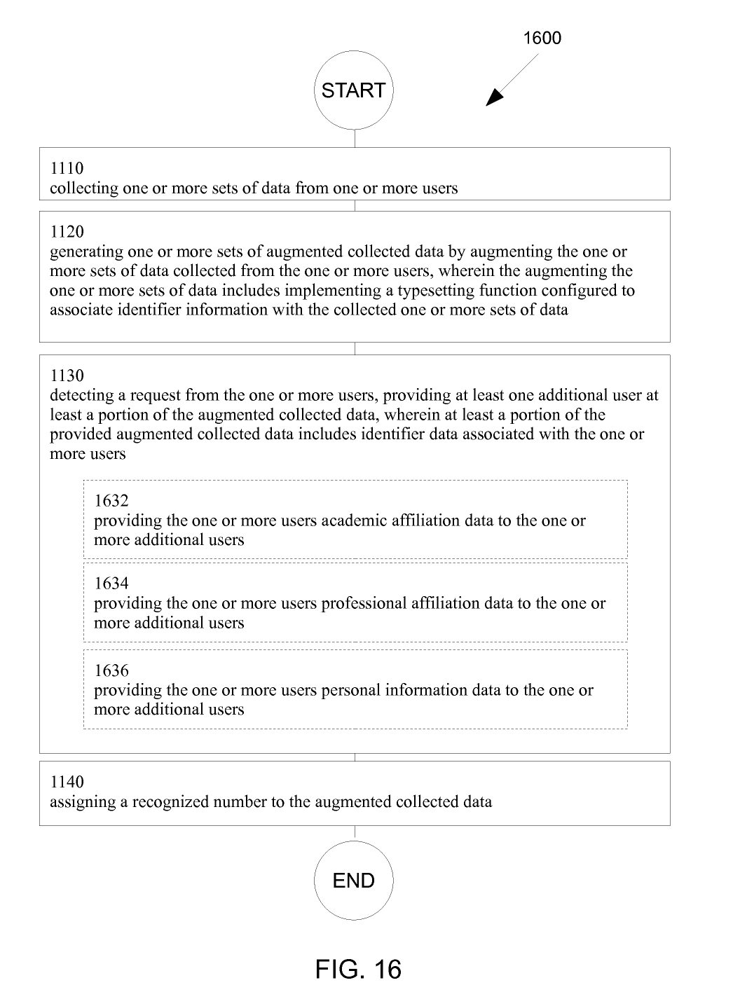

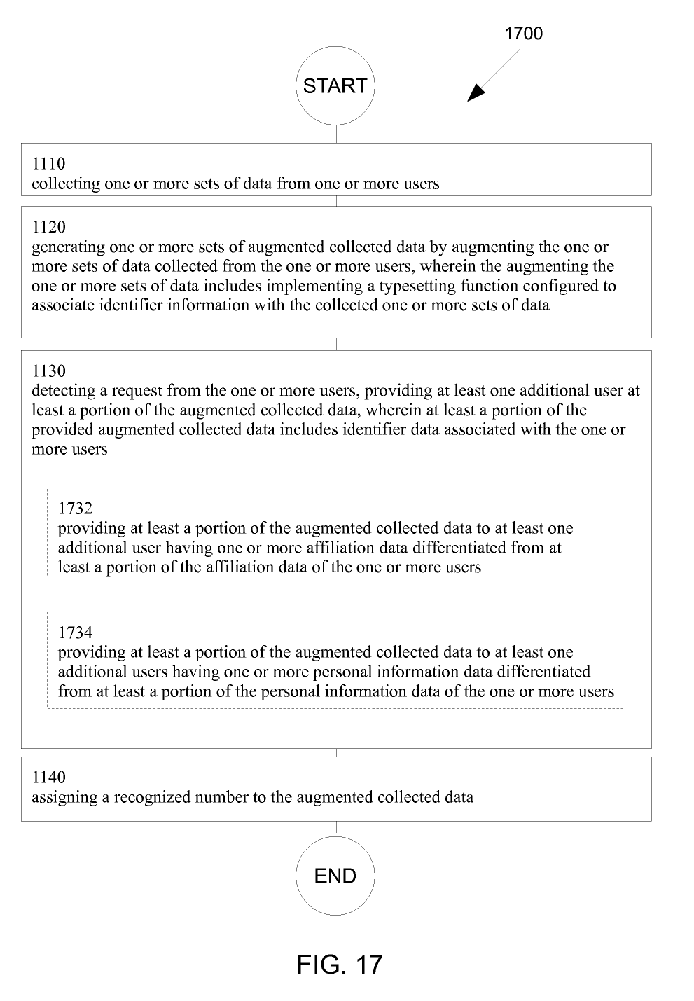

Operation 1130 may additionally include a process 1532 for detecting an action indicative of consent to make the augmented collected data available to the public as illustrated through process 1500 of FIG. 15. Operation 1130 may include further operations such as those illustrated through process 1600 of FIG. 16. These operations may include a process 1632 for providing the one or more users academic affiliation data to the one or more additional users, a process 1634 for providing the one or more users professional affiliation data to the one or more additional users, or a process 1636 for providing the one or more users personal information data to the one or more additional users. FIG. 17 illustrates yet further operational embodiments of operation 1130 through process 1700 such as process 1732 for providing at least a portion of the augmented collected data to at least one additional user having one or more affiliation data differentiated from at least a portion of the affiliation data of the one or more users, or a process 1734 for providing at least a portion of the augmented collected data to at least one additional user having one or more personal information data differentiated from at least a portion of the personal information data of the one or more users.

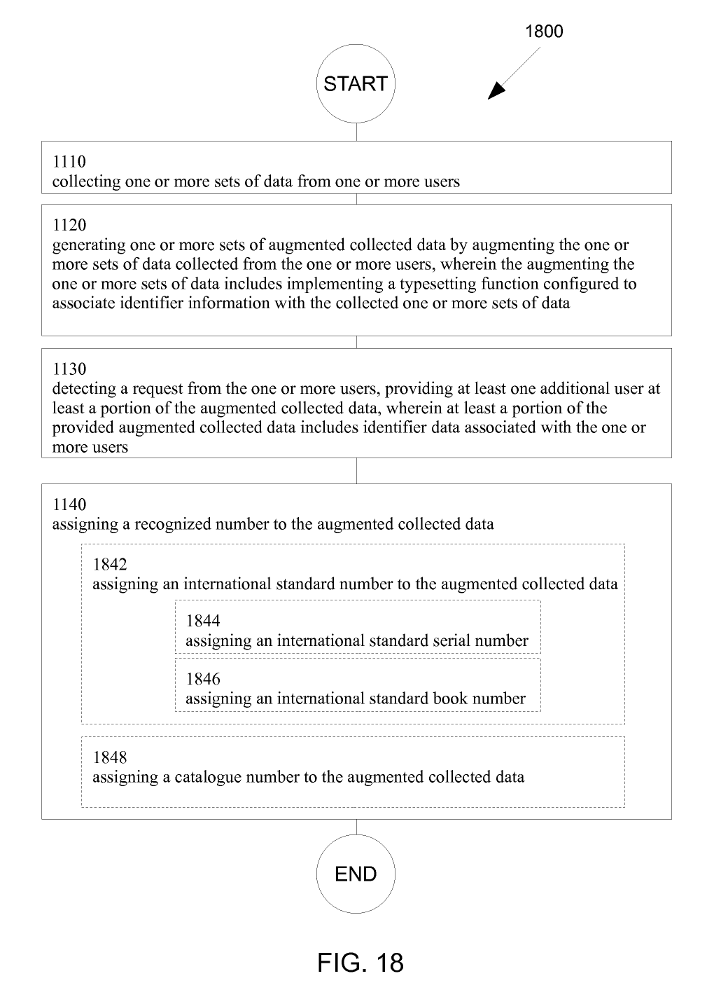

FIG. 18 illustrates a process 1800, wherein process 1140 may further include a process 1842 for assigning an international standard number to the augmented collected data, or a process 1848 for assigning a catalogue number to the augmented collected data. The process 1842 may further include a process 1844 for assigning an international standard serial number or a process 1846 for assigning an international standard book number.

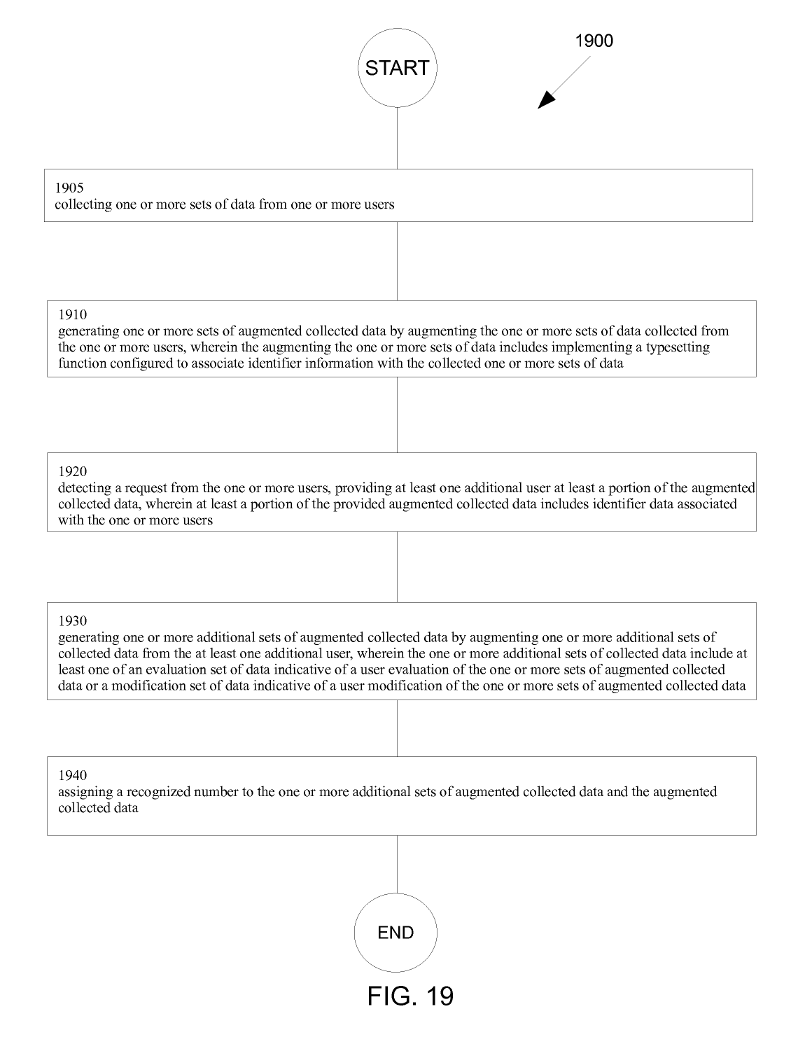

FIG. 19 through FIG. 27 represent additional flow processes which may include aspects of processes illustrated in FIG. 11 through 18. FIG. 19 illustrates a process 1900, wherein upon initiation of the process, 1900 generally includes a process for collecting one or more sets of data from one or more users 1905, generating one or more sets of augmented collected data by augmenting the one or more sets of data collected from the one or more users, wherein the augmenting the one or more sets of data includes implementing a typesetting function configured to associate identifier data with the collected one or more sets of data 1910, detecting a request from the one or more users, providing at least one additional user at least a portion of the identifier data associated with the one or more users and at least a portion of the identifier data associated with the augmented collected data 1920, generating one or more additional sets of augmented collected data by augmenting one or more additional sets of collected data from the at least one additional user, wherein the one or more additional sets of collected data include at least one of an evaluation set of data indicative of a user evaluation of the one or more sets of augmented collected data or a modification set of data indicative of a user modification of the one or more sets of augmented collected data 1930, and assigning a recognized number to the one or more additional sets of augmented collected data and the augmented collected data 1940.

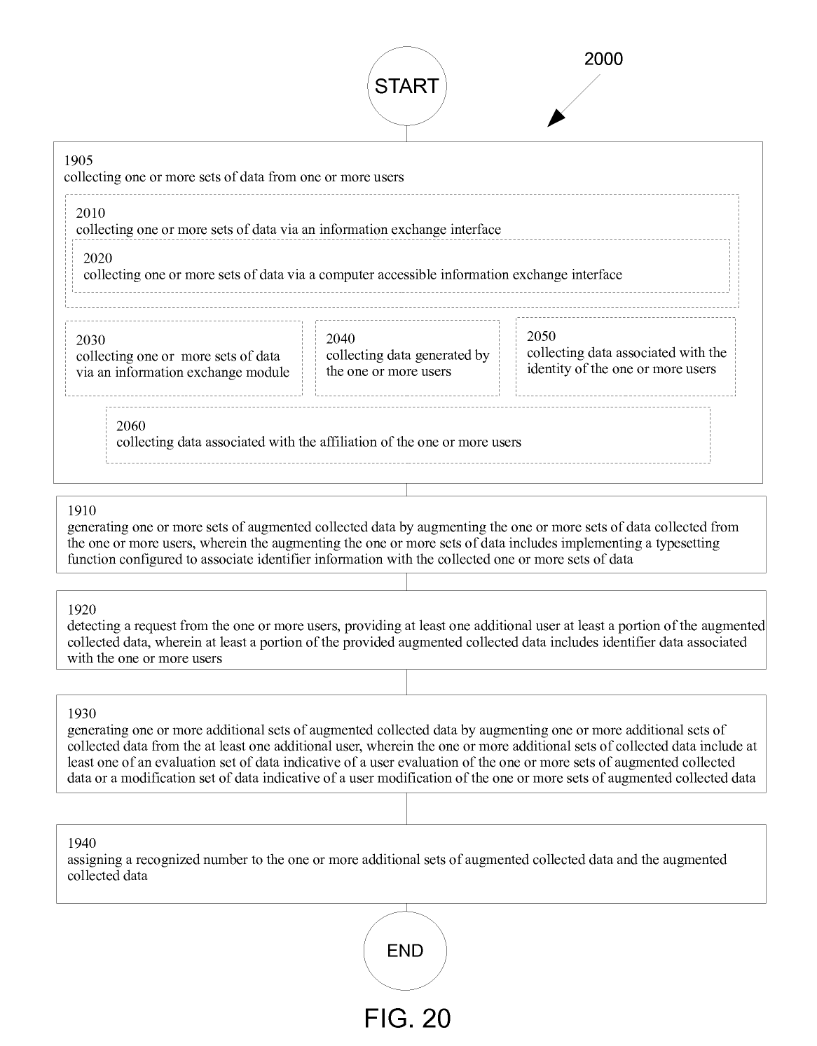

FIG. 20 illustrates an operation 2000 wherein the start of the operation is followed in further detail of operation 1905 by collecting one or more sets of data via an information exchange interface 2010. Operation 2010 may further be illustrated by collecting one or more sets of data via a computer accessible information exchange interface 2020. Operation 1905 may also include collecting one or more sets of data via an information exchange module 2030, collecting data generated by the one or more users 2040, collecting data associated with the identity of the one or more users 2050, or collecting data associated with the affiliation of the one or more users 2060. Operation 2000 may be included with operations 1910, 1920, 1930, or process 1940.

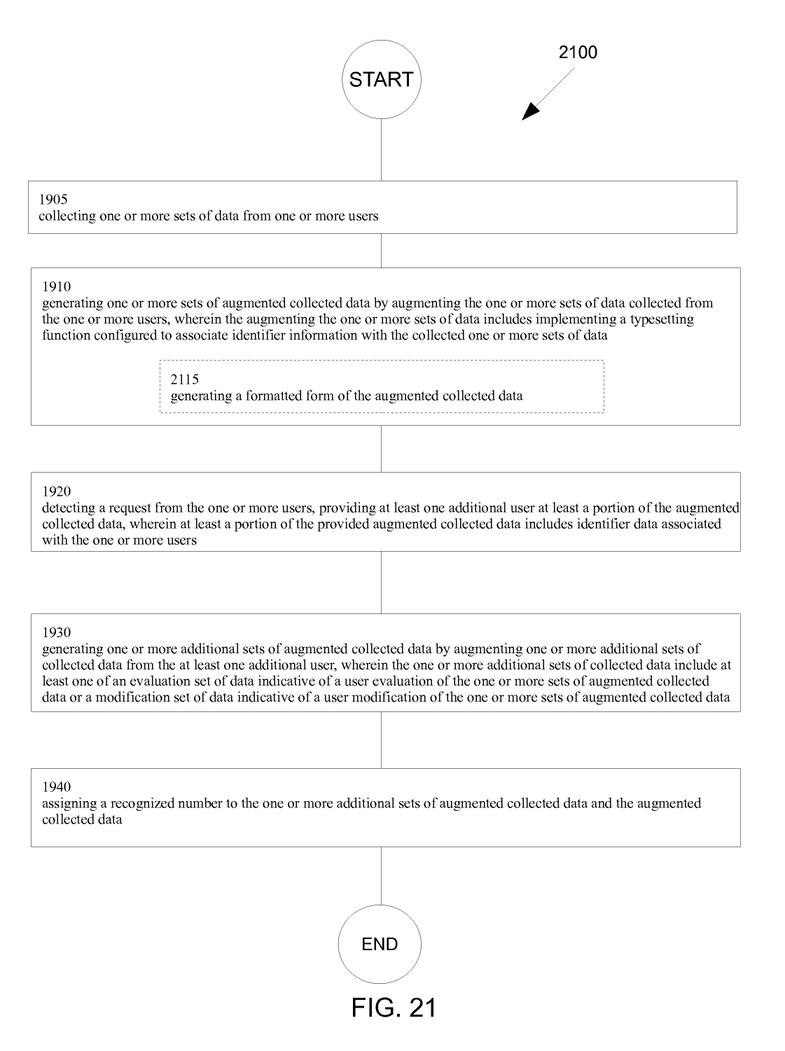

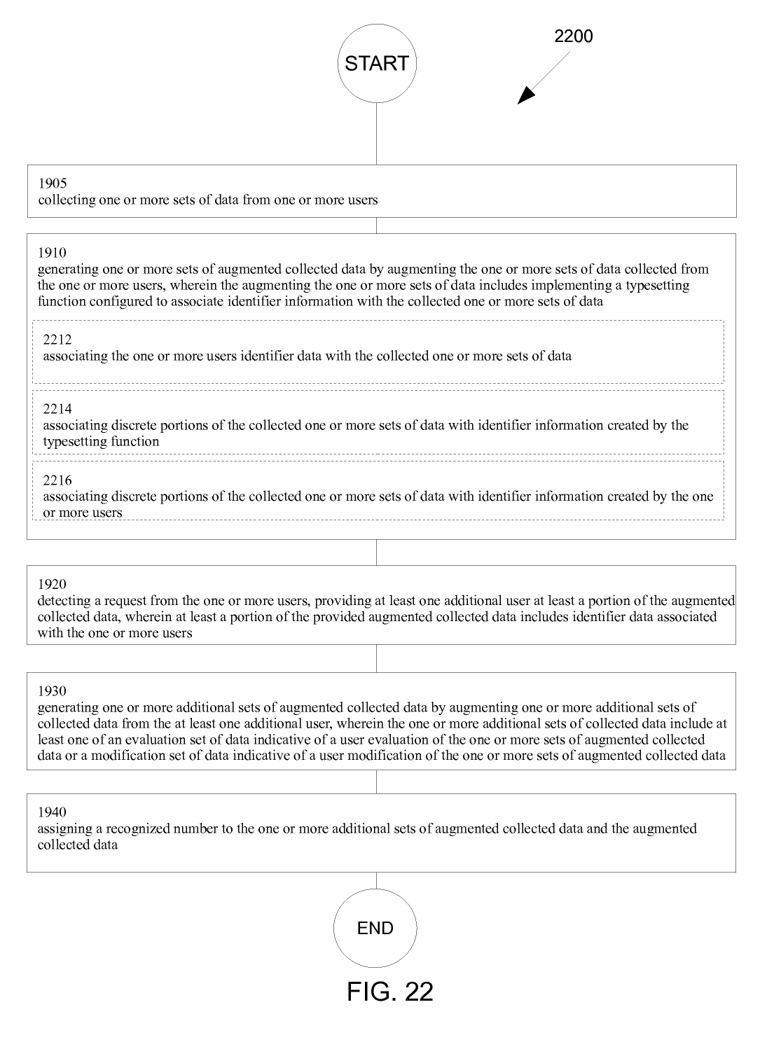

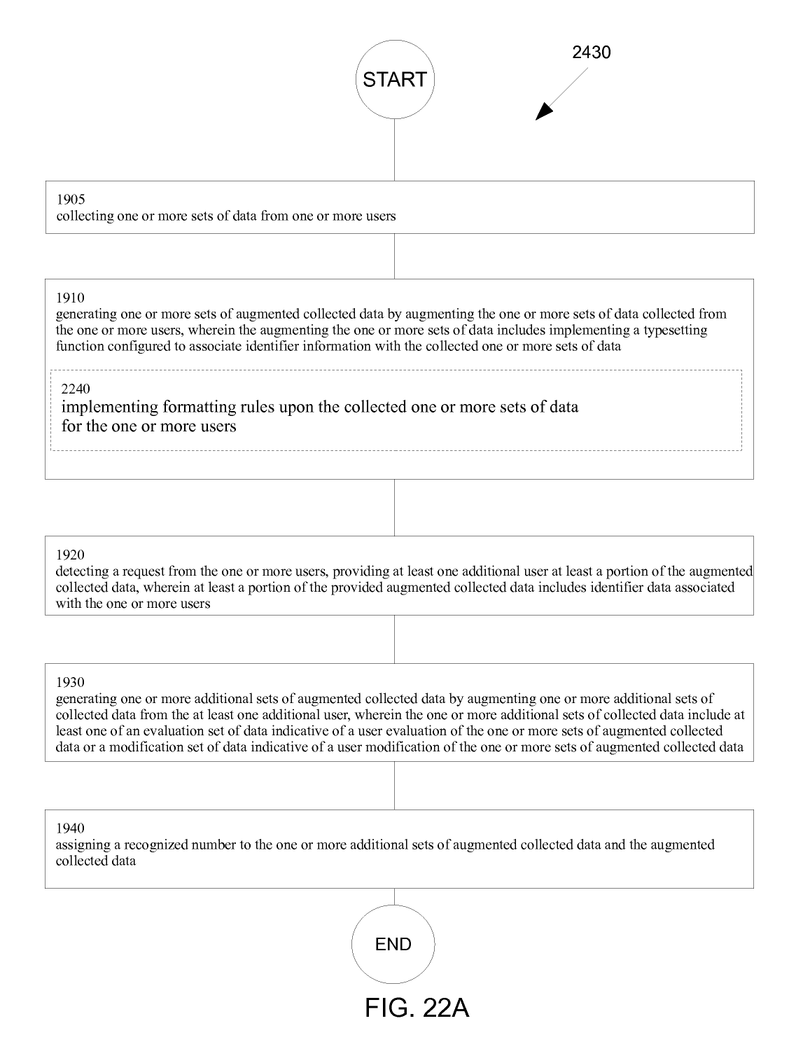

FIG. 21 illustrates a further embodiment through operation 2100. Operation 2100 includes operations 1905, 1910, 1920, 1930, or 1940. Operation 1910 may further include generating a formatted form of the augmented collected data 2115. Furthermore, as illustrated through operation 2200 of FIG. 22, operation 1910 may further include an operation 2212 for associating the one or more users identifier data with the collected one or more sets of data, an operation 2214 for associating discrete portions of the collected one or more sets of data with identifier information created by the typesetting function, or an operation 2216 for associating discrete portions of the collected one or more sets of data with identifier information created by the one or more users. Operation 1910 may further comprise a function 2240 for implementing formatting rules upon the collected one or more sets of data for the one or more users as illustrated in FIG. 22A via operation 2430.

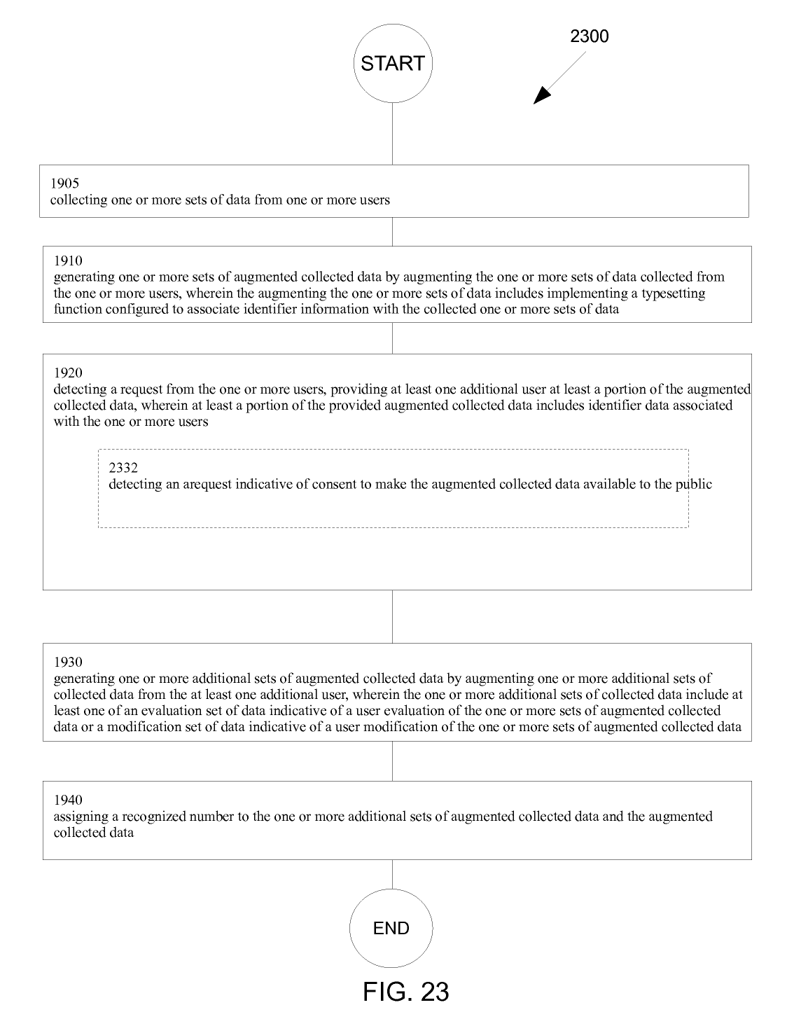

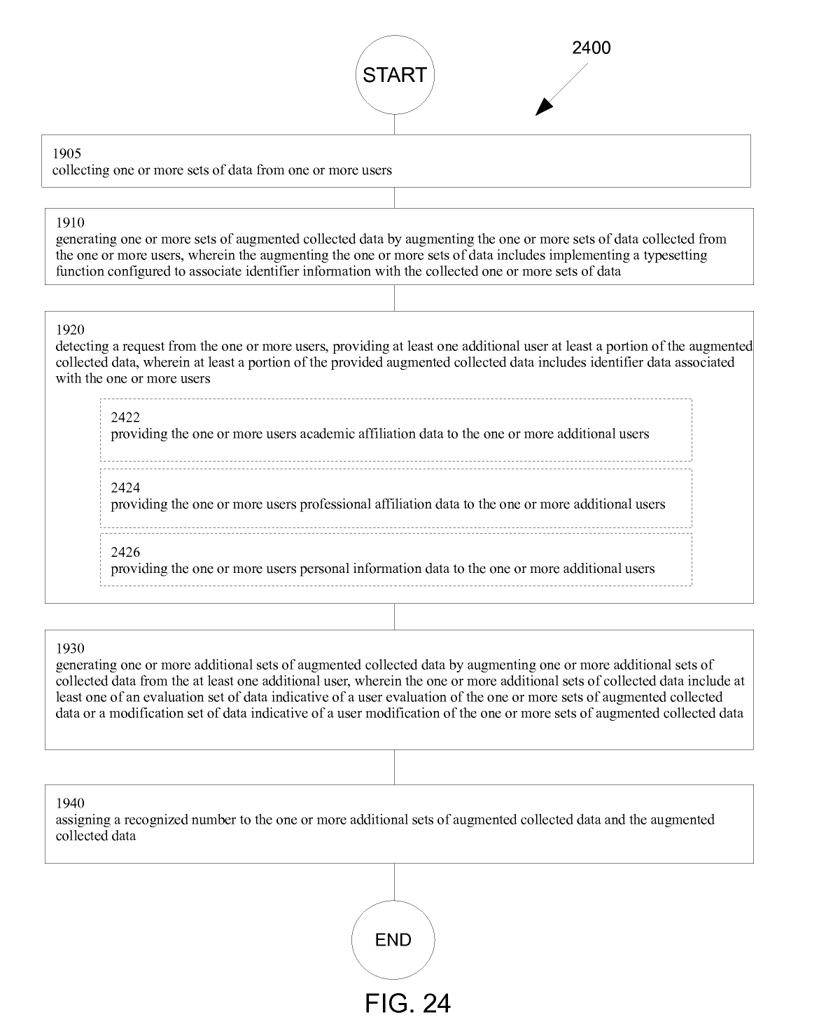

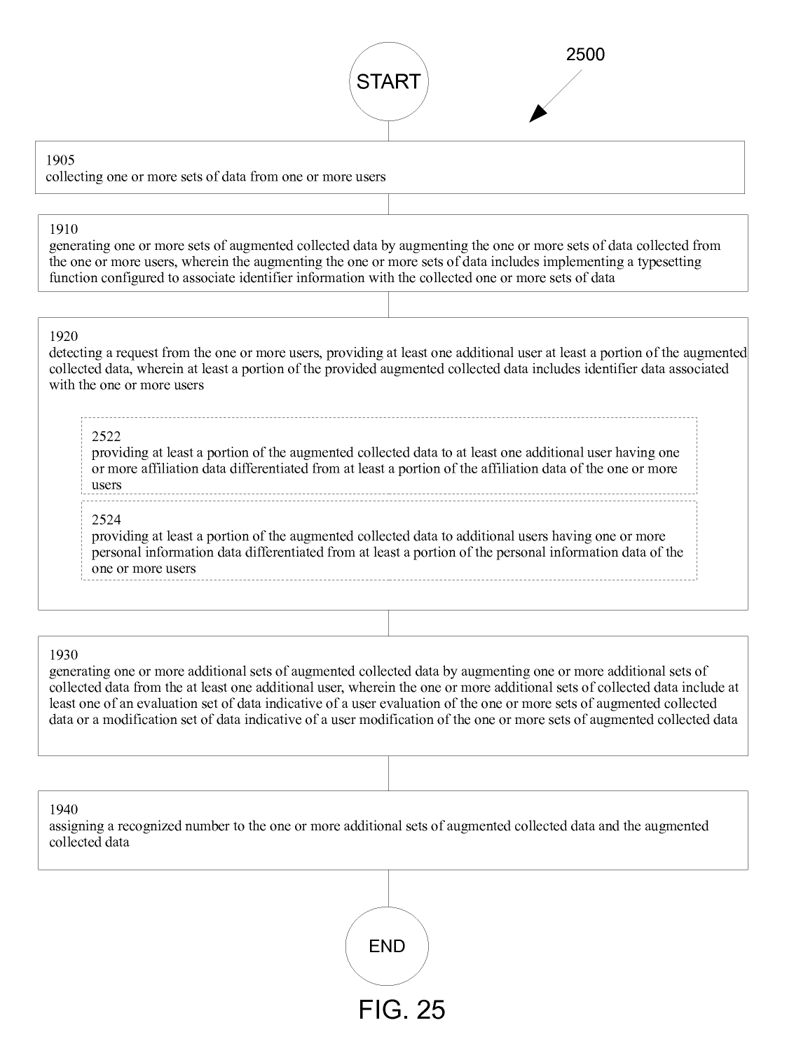

Operation 1920 may additionally include a process 2332 for detecting an action indicative of consent to make the augmented collected data available to the public as illustrated through process 2300 of FIG. 23. Operation 1920 may include further operations such as those illustrated through process 2400 of FIG. 24. These operations may include a process 2422 for providing the one or more users academic affiliation data to the one or more additional users, a process 2424 for providing the one or more users professional affiliation data to the one or more additional users, or a process 2426 for providing the one or more users personal information data to the one or more additional users. FIG. 25 illustrates yet further operational embodiments of operation 1920 through process 2500 such as process 2522 for providing at least a portion of the augmented collected data to at least one additional user having one or more affiliation data differentiated from at least a portion of the affiliation data of the one or more users, or a process 2524 for providing at least a portion of the augmented collected data to at least one additional user having one or more personal information data differentiated from at least a portion of the personal information data of the one or more users.

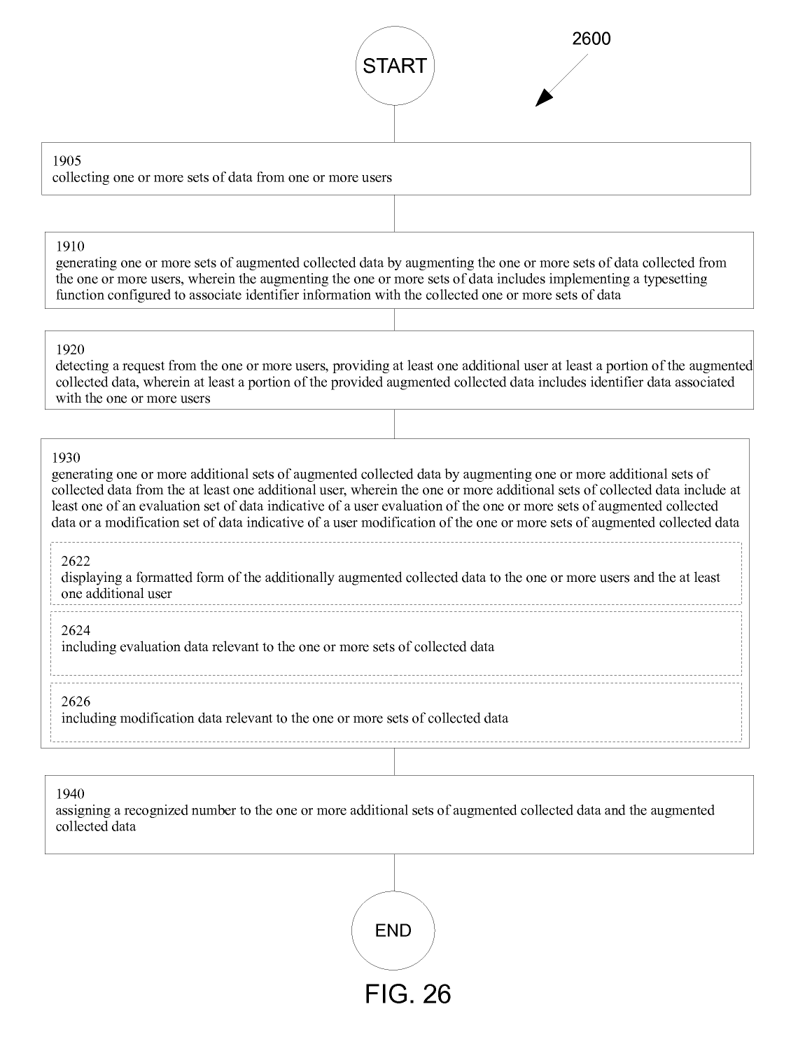

FIG. 26 illustrates a process 2600, wherein process 1930 may further comprise a process for displaying a formatted form of the additionally augmented collected data to the one or more users and the at least one additional user 2622, a process for including data relevant to the one or more sets of collected data 2624, or a process for including modification date relevant to the one or more sets of collected data 2626.

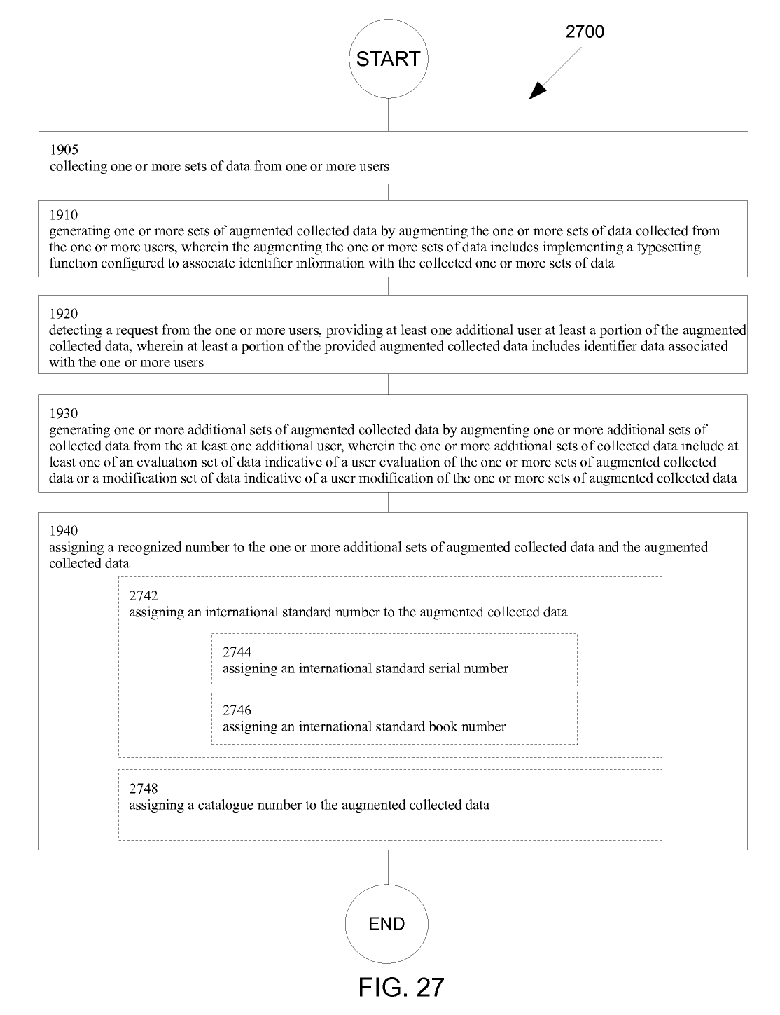

FIG. 27 illustrates a process 2700, wherein process 1940 may further include a process 2742 for assigning an international standard number to the augmented collected data, or a process 2748 for assigning a catalogue number to the augmented collected data. The process 2742 may further include a process 2744 for assigning an international standard serial number or a process 2746 for assigning an international standard book number.

1. A computer implemented method of publishing evaluated information comprising:
collecting one or more sets of data from one or more users;
generating one or more sets of augmented collected data by augmenting the one or more sets of data collected from the one or more users, wherein the augmenting the one or more sets of data includes implementing a typesetting function configured to associate identifier information with the collected one or more sets of data;
detecting a request from the one or more users, providing at least one additional user at least a portion of the augmented collected data, wherein at least a portion of the provided augmented collected data includes identifier data associated with the one or more users; and
assigning a recognized number to the augmented collected data.

2. The method of claim 1, wherein collecting one or more sets of data from one or more users comprises:
collecting one or more sets of data via an information exchange interface.

3. The method of claim 2, wherein collecting one or more sets of data via an information exchange interface comprises:
collecting one or more sets of data via a computer accessible information exchange interface.

4. The method of claim 1, wherein collecting one or more sets of data from one or more users comprises:
collecting one or more sets of data via an information exchange module.

5. The method of claim 1, wherein collecting one or more sets of data from one or more users comprises:
collecting data generated by the one or more users.

6. The method of claim 1, wherein collecting one or more sets of data from one or more users comprises:
collecting data associated with the identity of the one or more users.

7. The method of claim 1, wherein collecting one or more sets of data from one or more users comprises:
collecting data associated with the affiliation of the one or more users.

8. The method of claim 1, wherein generating one or more sets of augmented collected data by augmenting the one or more sets of data collected from the one or more users comprises:
generating a formatted form of the augmented collected data.

9. The method of claim 1, wherein associating identifier data with the collected one or more sets of data comprises:
associating the one or more users identifier data with the collected one or more sets of data.

10. The method of claim 1, wherein associating identifier information with the collected one or more sets of data comprises:
associating discrete portions of the collected one or more sets of data with identifier information created by the typesetting function.

11. The method of claim 1, wherein associating identifier information with the collected one or more sets of data comprises:
associating discrete portions of the collected one or more sets of data with identifier information created by the one or more users.

12. The method of claim 1, wherein implementing a typesetting function comprises:
implementing formatting rules upon the collected one or more sets of data for the one or more users.

13. The method of claim 1, wherein detecting a request from the one or more users comprises:
detecting an action indicative of consent to make the augmented collected data available to the public.

14. The method of claim 1, wherein providing identifier data associated with the one or more users comprises:
providing the one or more users academic affiliation data to the one or more additional users.

15. The method of claim 1, wherein providing identifier data associated with the one or more users comprises:
providing the one or more users professional affiliation data to the one or more additional users.

16. The method of claim 1, wherein providing identifier data associated with the one or more users comprises:
providing the one or more users personal information data to the one or more additional users.

17. The method of claim 1, wherein providing at least one additional user comprises:
providing at least a portion of the augmented collected data to at least one additional user having one or more affiliation data differentiated from at least a portion of the affiliation data of the one or more users.

18. The method of claim 1, wherein providing at least one additional user comprises:
providing at least a portion of the augmented collected data to at least one additional user having one or more personal information data differentiated from at least a portion of the personal information data of the one or more users.

19. The method of claim 1, wherein assigning a recognized number to the augmented collected data comprises:
assigning an international standard number to the augmented collected data.

20. The method of claim 19, wherein an international standard number comprises:
assigning an international standard serial number.

21. The method of claim 19, wherein an international standard number comprises:
assigning an international standard book number.

22. The method of claim 1, wherein assigning a recognized number to the augmented collected data comprises:
assigning a catalogue number to the augmented collected data.

23. A computer implemented method of sharing evaluated information comprising:
collecting one or more sets of data from one or more users;
generating one or more sets of augmented collected data by augmenting the one or more sets of data collected from the one or more users, wherein the augmenting the one or more sets of data includes implementing a typesetting function configured to associate identifier data with the collected one or more sets of data;
detecting a request from the one or more users, providing at least one additional user at least a portion of the identifier data associated with the one or more users and at least a portion of the identifier data associated with the augmented collected data;
generating one or more additional sets of augmented collected data by augmenting one or more additional sets of collected data from the at least one additional user, wherein the one or more additional sets of collected data include at least one of an evaluation set of data indicative of a user evaluation of the one or more sets of augmented collected data or a modification set of data indicative of a user modification of the one or more sets of augmented collected data; and
assigning a recognized number to the one or more additional sets of augmented collected data and the augmented collected data.

24. The method of claim 23, wherein collecting one or more sets of data from one or more users comprises:
collecting one or more sets of data via an information exchange interface.

25. The method of claim 24, wherein collecting one or more sets of data via an information exchange interface comprises:
collecting one or more sets of data via a computer accessible information exchange interface.

26. The method of claim 23, wherein collecting one or more sets of data from one or more users comprises:
collecting one or more sets of data via an information exchange module.

27. The method of claim 23, wherein collecting one or more sets of data from one or more users comprises:
collecting data generated by the one or more users.

28. The method of claim 23, wherein collecting one or more sets of data from one or more users comprises:
collecting data associated with the identity of the one or more users.

29. The method of claim 23, wherein collecting one or more sets of data from one or more users comprises:
collecting data associated with the affiliation of the one or more users.

30. The method of claim 23, wherein generating one or more sets of augmented collected data by augmenting the one or more sets of data collected from the one or more users comprises:
generating a formatted form of the augmented collected data.

31. The method of claim 23, wherein associating identifier information with the collected one or more sets of data comprises:
associating at least a portion of the one or more users identifier information with the collected one or more sets of data.

32. The method of claim 23, wherein associating identifier information with the collected one or more set of data comprises:
associating discrete portions of the collected one or more sets of data with identifier information created by implementing the typesetting function.

33. The method of claim 23, wherein associating identifier information with the collected data comprises:
associating discrete portions of the collected data with identifier information created by the one or more users.

34. The method of claim 23, wherein implementing a typesetting function comprises:
implementing formatting rules upon the one or more sets of collected data from the one or more users.

35. The method of claim 23, wherein upon a request from the one or more users comprises:
upon an action indication of consent to make the augmented collected data available to the public.

36. The method of claim 23, wherein providing identifier data associated with the one or more users comprises:
providing the one or more users academic affiliation data to the one or more additional users.

37. The method of claim 23, wherein providing identifier data associated with the one or more users comprises:
providing the one or more users professional affiliation data to the one or more additional users.

38. The method of claim 23, wherein providing identifier data associated with the one or more users comprises:
providing the one or more users personal information data to the one or more additional users.

39. The method of claim 23, wherein providing at least a portion of the augmented collected data to at least one additional user comprises:
providing at least a portion of the augmented collected data to at least one additional user having one or more affiliation data differentiated from at least a portion of the affiliation data of the one or more users.

40. The method of claim 23, wherein providing at least a portion of the augmented collected data to at least one additional user comprises:
providing at least a portion of the augmented collected data to at least one additional user having one or more personal information data differentiated from at least a portion of the personal information data of the one or more users.

41. The method of claim 23, wherein generating one or more additional sets of augmented collected data by augmenting one or more additional sets of collected data from the at least one additional user comprises:
displaying a formatted form of the additionally augmented collected data to the one or more users and the at least one additional user.

42. The method of claim 23, wherein an evaluation set of data indicative of a user evaluation of the one or more sets of augmented collected data comprises:
including evaluation data relevant to the one or more sets of collected data.

43. The method of claim 23, wherein a modification set of data indicative of a user modification of the one or more sets of augment collected data comprises:
including modification data relevant to the one or more sets of collected data.

44. The method of claim 23, wherein assigning a recognized number to the one or more additionally augmented sets of data and the augmented collected data comprises:
assigning an international standard number to the augmented collected data.

45. The method of claim 44, wherein an international standard number comprises:
an international standard serial number.

46. The method of claim 44, wherein an international standard number comprises:
an international standard book number.

47. The method of claim 23, wherein assigning a recognized number to the one or more additionally augmented sets of data and the augmented collected data comprises:
assigning a catalogue number to the collected data.

48. A system for sharing evaluated information comprising:
one or more processors coupled to memory, wherein the memory stores program instructions executable by the one or more processors in order to implement:
an information exchange module to collect one or more sets of data from one or more users;
an augmentation module to generate one or more sets of augmented collected data by augmenting the one or more sets of data collected from the one or more users, wherein at least a portion of the augmenting includes initiating a typesetting function associating identifier information with the collected data;
a request module to implement a request from the one or more users
a display module to provide at least one additional user at least a portion of identification data associated with the one or more users and at least a portion of identification data associated with the augmented collected data;
an additional augmentation module to generate one or more additional sets of augmented collected data by augmenting one or more additional sets of collected data from the at least one additional user, wherein the one or more additional sets of data include at least one of an evaluation set of data indicative of a user evaluation of the one or more sets of augmented collected data or a modification set of data indicative of a user modification of the one or more sets of augment collected data;
an assignment module to assign a recognized number to the one or more additional sets of augmented collected data and the augmented collected data.

49. The system of claim 48, wherein an information exchange module to collect one or more sets of data from one or more users comprises:
a module coupleable to one or more information exchange interface.

50. The system of claim 49, wherein one or more information exchange interface comprises:
a computer accessible information exchange interface.

51. The system of claim 48, wherein an information exchange module to collect one or more sets of data from one or more users comprises:
a module configured to provide a data input template.

52. The system of claim 48, wherein an information exchange module to collect one or more sets of data from one or more users comprises:
a module configured to collect data generated by the one or more users.

53. The system of claim 48, wherein an information exchange module to collect one or more sets of data from one or more users comprises:
a module configured to collect data associated with the identity of the one or more users.

54. The system of claim 48, wherein an information exchange module to collect one or more sets of data from one or more users comprises:
a module configured to collect data associated with the affiliation of the one or more users.

55. The system of claim 48, wherein an augmentation module to generate one or more sets of augmented collected data by augmenting the one or more sets of data collected from the one or more users, wherein at least a portion of the augmenting includes initiating a typesetting function associating identifier data with the collected data comprises:
a module to generate a formatted form of the augmented collected data.

56. The system of claim 48, wherein an augmentation module to generate one or more sets of augmented collected data by augmenting the one or more sets of data collected from the one or more users, wherein at least a portion of the augmenting includes initiating a typesetting function associating identifier data with the collected data comprises:
a module to associate at least a portion of the one or more users identifier data with the collected data.

57. The method of claim 48, wherein an augmentation module to generate one or more sets of augmented collected data by augmenting the one or more sets of data collected from the one or more users, wherein at least a portion of the augmenting includes initiating a typesetting function associating identifier data with the collected data comprises:
a module to associate discrete portions of the collected data with identifier data created by the typesetting function.

58. The method of claim 48, wherein an augmentation module to generate one or more sets of augmented collected data by augmenting the one or more sets of data collected from the one or more users, wherein at least a portion of the augmenting includes initiating a typesetting function associating identifier data with the collected data comprises:
a module to associate discrete portions of the collected data with identifier data created by the one or more users.

59. The system of claim 48, wherein a typesetting function comprises:
a function for implementing formatting rules upon the one or more sets of collected data from the one or more users.

60. The system of claim 48, wherein a request module to implement a request from the one or more users comprises:
a module to make the augmented collected data available to the public upon an action indicative of consent.

61. The system of claim 48, wherein a display module to provide at least one additional user at least a portion of identifier data associated with the one or more users and at least a portion of identifier data associated with the augmented collected data comprises:
a module to display the one or more users academic affiliation data to the one or more additional users.

62. The system of claim 48, wherein a display module to provide at least one additional user at least a portion of identifier data associated with the one or more users and at least a portion of identifier data associated with the augmented collected data comprises:
a module to display the one or more users professional affiliation data to the one or more additional users.

63. The system of claim 48, wherein a display module to provide at least one additional user at least a portion of identifier data associated with the one or more users and at least a portion of identifier data associated with the augmented collected data comprises:
a module to display the one or more users personal information data to the one or more additional users.

64. The system of claim 48, wherein a display module to provide at least one additional user at least a portion of identification data associated with the one or more users and at least a portion of identification data associated with the augmented collected data comprises:
a display module to provide at least a portion of identifier data associated with the one or more users and at least a portion of identifier data associated with the augmented collected data to the at least one additional user, the at least one additional user having one or more identifier data differentiated from at least a portion of the identifier data of the one or more users.

65. The system of claim 48, wherein an additional augmentation module to generate one or more additional sets of augmented collected data by augmenting one or more additional sets of collected data from the at least one additional user, wherein the one or more additional sets of data include at least one of an evaluation set of data indicative of a user evaluation of the one or more sets of augmented collected data or a modification set of data indicative of a user modification of the one or more sets of augment collected data comprises:
an additional augmentation module for displaying a formatted form of the additionally augmented collected data to the one or more users and the at least one additional user.

66. The system of claim 48, wherein an additional augmentation module to generate one or more additional sets of augmented collected data by augmenting one or more additional sets of collected data from the at least one additional user, wherein the one or more additional sets of data include at least one of an evaluation set of data indicative of a user evaluation of the one or more sets of augmented collected data or a modification set of data indicative of a user modification of the one or more sets of augment collected data comprises:
an additional augmentation module for augmenting data relevant to the one or more sets of collected data.

67. The system of claim 48, wherein an additional augmentation module to generate one or more additional sets of augmented collected data by augmenting one or more additional sets of collected data from the at least one additional user, wherein the one or more additional sets of data include at least one of an evaluation set of data indicative of a user evaluation of the one or more sets of augmented collected data or a modification set of data indicative of a user modification of the one or more sets of augment collected data comprises:
an additional augmentation module for augmenting modifications relevant to the one or more sets of collected data.

68. The system of claim 48, wherein an assignment module to assign a recognized number to the one or more additional sets of augmented collected data and the augmented collected data comprises:
an assignment module for assigning an international standard number to the augmented collected data.

69. The system of claim 68, wherein an an assignment module for assigning an international standard number to the augmented collected data comprises:
an assignment module for assigning an international standard serial number to the augmented collected data.

70. The method of claim 68, wherein an assignment module for assigning an international standard number to the augmented collected data comprises:
an assignment module for assigning an international standard book number to the augmented collected data.

71. The method of claim 44, wherein an assignment module to assign a recognized number to the one or more additional sets of augmented collected data and the augmented collected data comprises:
an assignment module for assigning a catalogue number to the augmented collected data.
